(19) United States
(12) Patent Application Publication
(10) Pub. No.: US 2026/0138073 A1
(43) Pub. Date: May 21, 2026

(54) SYSTEM AND METHOD FOR GAS TREATMENT VIA MOVABLE ADSORPTION MODULE AND THERMAL CONTROL

(71) Applicant: GE Electric Technology GMBH, Baden (CH)

(72) Inventors: Majed SAMMAK, Dubai (AE); Parag P. KULKARNI, Schenectady, NY (US)

(21) Appl. No.: 19/121,011

(22) PCT Filed: Oct. 20, 2022
(86) PCT No.: PCT/US2022/047324

§ 371 Date: Apr. 14, 2025

(51) Int. Cl. B01D 53/04

(52) U.S. Cl. CPC B01D 53/0438; B01D 53/0415; B01D 53/0454; B01D 2257/504; B01D 2259/40098

(57) ABSTRACT

A gas treatment system having an adsorption module, wherein the adsorption module includes a sorbent material. The gas treatment system further includes a positioning assembly configured to move the adsorption module in alternating directions along a path of travel between a first position in a first flow path and a second position in a second flow path. The gas treatment system is configured to adsorb an undesirable gas from a first fluid flow in the first flow path into the sorbent material when the adsorption module is disposed in the first position. The gas treatment system is configured to desorb the undesirable gas from the sorbent material when the adsorption module is disposed in the second position. The gas treatment system also includes a thermal control system having a first heat exchanger disposed in the first flow path and a second heat exchanger disposed in the second flow path.

### BACKGROUND

The present application relates generally to a system and method for treating a gas, such as a gas fuel or an exhaust gas.

An industrial plant, such as a power plant, may consume or produce a variety of gases, such as a fuel gas (e.g., natural gas or synthesis gas) and/or an exhaust gas of a combustion system. The combustion system may include a gas turbine engine, a reciprocating piston-cylinder engine, a furnace, a boiler, or other industrial equipment. These gases may include one or more undesirable gases, such as acid gases and/or exhaust emissions gases. For example, the undesirable gases may include hydrogen sulfide (H₂S), carbon oxides (COx) such as carbon dioxide (CO₂), nitrogen oxides (NOx) such as nitrogen dioxide (NO₂), and/or sulfur oxides (SOx) such as sulfur dioxide (SO₂). Accordingly, it may be desirable to treat certain gases to remove the undesirable gases from a gas flow, such as by removing the undesirable gases from the fuel gas upstream of the combustion system and/or removing the undesirable gases from the exhaust gas discharged by the combustion system. A gas treatment system may include a solvent-based absorption system configured to absorb the undesirable gases into a solvent, which subsequently flows through a solvent regeneration system to remove the undesirable gases. However, the solvent-based absorption system generally includes a variety of equipment external to a duct (e.g., fuel supply duct or exhaust duct) carrying the gas flow, and thus can increase the costs, complexity, and footprint of the solvent-based absorption system. Accordingly, a need exists for a gas treatment system that can operate continuously without relying on a solvent-based absorption system.

### BRIEF DESCRIPTION

Certain embodiments commensurate in scope with the originally claimed subject matter are summarized below. These embodiments are not intended to limit the scope of the claimed embodiments, but rather these embodiments are intended only to provide a brief summary of possible forms of the subject matter. Indeed, the presently claimed embodiments may encompass a variety of forms that may be similar to or different from the embodiments set forth below.

In certain embodiments, a system includes a gas treatment system having an adsorption module, wherein the adsorption module includes a sorbent material. The gas treatment system further includes a positioning assembly configured to move the adsorption module in alternating directions along a path of travel between a first position in a first flow path and a second position in a second flow path. The gas treatment system is configured to adsorb an undesirable gas from a first fluid flow in the first flow path into the sorbent material when the adsorption module is disposed in the first position. The gas treatment system is configured to desorb the undesirable gas from the sorbent material when the adsorption module is disposed in the second position. The gas treatment system also includes a thermal control system having a first heat exchanger disposed in the first flow path and a second heat exchanger disposed in the second flow path.

In certain embodiments, a system includes a first duct having a first flow path, a second duct having a second flow path, and a plurality of adsorption modules, wherein each adsorption module of the plurality of adsorption modules includes a sorbent material. The system further includes a plurality of positioning assemblies, wherein each positioning assembly of the plurality of positioning assemblies is configured to independently move one of the plurality of adsorption modules in alternating directions between the first and second ducts. The system also includes a thermal control system having a first heat exchanger disposed in the first flow path and a second heat exchanger disposed in the second flow path.

In certain embodiments, a method includes moving, via a positioning assembly, an adsorption module of a gas treatment system in alternating directions along a path of travel between a first position in a first flow path and a second position in a second flow path, wherein the adsorption module includes a sorbent material. The method includes adsorbing an undesirable gas into the sorbent material of the adsorption module when the adsorption module is disposed in the first position in the first flow path. The method includes controlling a first temperature in the first flow path via a first heat exchanger of a thermal control system, wherein the first heat exchanger is disposed in the first flow path. The method includes desorbing the undesirable gas from the sorbent material of the adsorption module when the adsorption module is disposed in the second position in the second flow path. The method includes controlling a second temperature in the second flow path via a second heat exchanger of the thermal control system, wherein the second heat exchanger is disposed in the second flow path.

### BRIEF DESCRIPTION OF THE DRAWINGS

These and other features, aspects, and advantages of the presently disclosed techniques will become better understood when the following detailed description is read with reference to the accompanying drawings in which like characters represent like parts throughout the drawings, wherein:

FIG. 1 is a schematic of an embodiment of a gas turbine system having a gas treatment system having one or more adsorption modules configured to remove an undesirable gas.

FIG. 2 is a schematic of an embodiment of the gas treatment system of FIG. 1, further illustrating an adsorption system having a plurality of moveable adsorption assemblies, each having an adsorption module that moves linearly between first and second ducts via a linear positioning assembly, wherein a thermal control system provides temperature control for the adsorption system.

FIG. 3 is a schematic of an embodiment of a temperature control system having heat exchangers configured to providing heating and/or cooling for the gas treatment system of FIGS. 1 and 2.

FIG. 4 is a schematic of an embodiment of a direct heat exchange system having a fluid distribution manifold with a plurality of nozzles configured to inject a fluid for direct heat transfer in the gas treatment system of FIGS. 1 and 2.

FIG. 5 is a perspective view of an embodiment of the adsorption module of FIGS. 1 and 2, further illustrating a sorbent cartridge disposed in a framework of the adsorption module.

FIG. 6 is a perspective view of an embodiment of the adsorption module of FIGS. 1 and 2, further illustrating a plurality of sorbent cartridges disposed in respective cartridge openings in the framework of the adsorption module, wherein each of the plurality of sorbent cartridges is independently removable for servicing and replacement.

FIG. 7 is a partial schematic view of an embodiment of the moveable adsorption assembly of FIG. 2, further illustrating details of the linear positioning assembly having slides disposed in rails of respective rail assemblies.

FIG. 8 is a partial cross-sectional view of an embodiment of the rail assembly coupled to the adsorption module, further illustrating details of one of the slides disposed in a respective rail.

FIG. 9 is a schematic view of an embodiment of the moveable adsorption assembly of FIG. 2, further illustrating details of a seal disposed about an opening in an intermediate wall between the first and second ducts.

FIG. 10 is a partial cross-sectional view of an embodiment of the moveable adsorption assembly taken along line 10-10 of FIG. 9, further illustrating details of the seal having fibers of a brush seal disposed against the adsorption module.

FIG. 11 is a schematic view of an embodiment of the moveable adsorption assembly of FIG. 2, further illustrating details of an access panel disposed over an access opening in the first duct to enable insertion and removal of the adsorption module.

FIG. 12 is a partial perspective view of an embodiment of the gas treatment system of FIG. 2, further illustrating details of the adsorption module partially removed from the first duct via the access opening.

FIG. 13 is a partial cross-sectional view of an embodiment of the access panel coupled to the first duct of FIGS. 2, 11, and 12.

FIG. 14 is a flow chart of an embodiment of a process for treating gas via a moveable adsorption assembly having an adsorption module that moves between first and second ducts to perform adsorption and desorption, respectively.

FIG. 15 is a schematic of an embodiment of the gas treatment system of FIGS. 1-14, further illustrating details of the thermal control system of FIG. 2, wherein the thermal control system includes a cooling system having a cooling supply system and a heating system having a heating supply system.

FIG. 16 is a schematic of an embodiment of the gas treatment system of FIGS. 1-15, further illustrating details of single fluid systems of the cooling supply system and the heating supply system of the thermal control system of FIG. 15.

FIG. 17 is a schematic of an embodiment of the gas treatment system of FIGS. 1-15, further illustrating aspects of multi-fluid systems of the cooling supply system and the heating supply system of the thermal control system of FIG. 15.

FIG. 18 is a schematic of an embodiment of the gas treatment system of FIGS. 1-17, further illustrating aspects of a heat exchange system of the thermal control system of FIGS. 2 and 15-17.

FIG. 19 is a flow chart of an embodiment of a gas treatment process of the gas treatment system of FIGS. 1-18.

FIG. 20 is a block diagram of an embodiment of a combined cycle power plant having the gas turbine system of FIG. 1, further illustrating details of the adsorption system and the thermal control system of the gas treatment system.

### DETAILED DESCRIPTION

One or more specific embodiments of the presently disclosed systems are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the presently disclosed embodiments, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include gas treatment systems and methods to enable gas treatment using a plurality of adsorption modules and a thermal control system, which provides temperature control for the plurality of adsorption modules. As discussed below, the thermal control system is configured to provide direct heat exchange, indirect heat exchange, or a combination thereof, to control the temperature of the plurality of adsorption modules to facilitate adsorption and desorption of undesirable gases. For example, heat exchangers may be disposed upstream of the plurality of adsorption modules, directly at each of the plurality of adsorption modules, or between successive adsorption modules to provide temperature control. The thermal control system may include one or more heat exchangers configured to operate as heaters or heating systems, one or more heat exchangers configured to operate as coolers or cooling systems, or a combination thereof. In some embodiments, the heat exchangers may be disposed along a common heat transfer circuit and/or the heat exchangers may be arranged in a heat pump cycle or refrigeration cycle.

In certain embodiments, the plurality of adsorption modules are configured to move back and forth between a first duct to perform adsorption of undesirable gases and a second duct to perform desorption of the undesirable gases. The first and second ducts may be disposed adjacent and along one another, such that the adsorption modules can move directly between and inside of the first and second ducts. The adsorption modules may be configured to move linearly between the ducts along rail assemblies, which may be oriented crosswise (e.g., perpendicular) to longitudinal axes of the first and second ducts. The adsorption modules may include one or more removable sorbent cartridges, which can be removed and replaced independently from one another. The adsorption modules also may be accessible via access panels in the first duct and/or the second duct to perform inspections, servicing, replacements, or other maintenance procedures. The adsorption modules also may be moved back and forth between the first and second ducts in a staggered manner, such that one or more adsorption modules are adsorbing the undesirable gases in the first duct while one or more adsorption modules are desorbing the undesirable gases in the second duct. Various aspects and embodiments of the gas treatment system are discussed in further detail below.

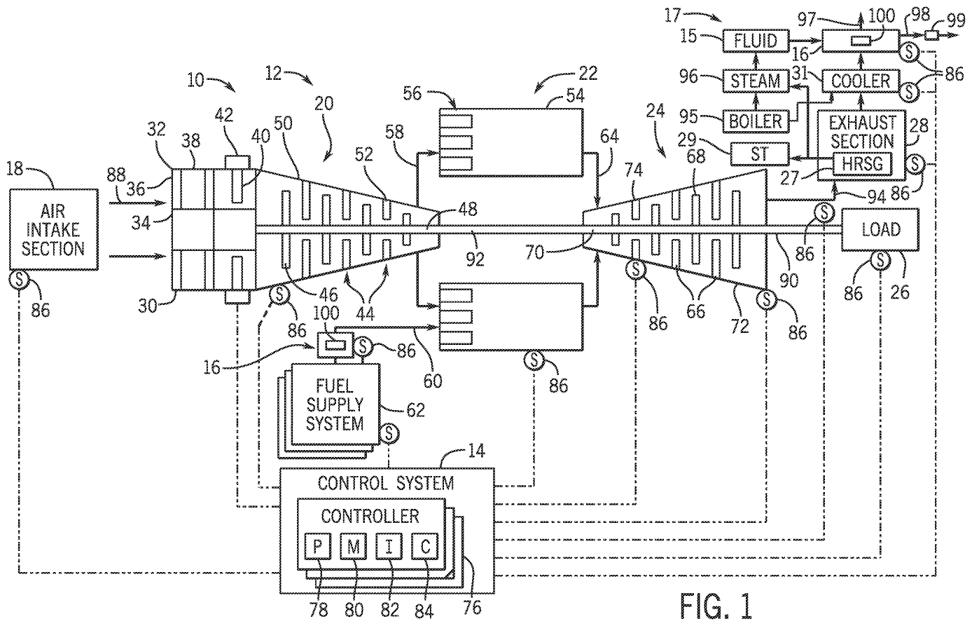

FIG. 1 is a block diagram of an embodiment of a gas turbine system 10 having a gas turbine engine 12 coupled to a control system 14. As discussed in further detail below, the gas turbine system 10 may include a gas treatment system 16 to treat one or more gases in the gas turbine system 10. The various features of the gas treatment system 16 are discussed in further detail below, and the various features may be used in any suitable combination with one another. However, before moving on to the gas treatment system 16, the gas turbine system 10 will be described as one possible context for use of the gas treatment system 16.

The gas turbine engine 12 includes an air intake section 18, a compressor section 20, a combustor section 22, a turbine section 24, a load 26, and an exhaust section 28. The air intake section 18 may include a duct having one or more silencer baffles, fluid injection systems (e.g., heated fluid injection for anti-icing), air filters, or any combination thereof. The compressor section 20 may include an upstream inlet duct 30 having a bell mouth 32, wherein the inlet duct 30 includes an air intake path between an inner hub 34 and an outer wall 36. The inlet duct 30 also includes stationary vanes 38 and inlet guide vanes (IGVs) 40. The inlet guide vanes 40 also may be coupled to one or more actuators 42, which are communicatively coupled to and controlled by the control system 14.

The compressor section 20 includes one or more compressor stages 44, wherein each compressor stage 44 includes a plurality of compressor blades 46 coupled to a compressor shaft 48 within a compressor casing 50, and a plurality of compressor vanes 52 coupled to the compressor casing 50. The compressor blades 46 and the compressor vanes 52 are arranged circumferentially about a central axis of the compressor shaft 48 within each compressor stage 44. The compressor stages 44 may include between 1 and 30 or more compressor stages. Additionally, the compressor stages 44 alternative between sets of the compressor blades 46 and sets of the compressor vanes 52 in the direction of air flow through the compressor section 20. In operation, the compressor stages 44 progressively compress the intake air flow before delivery to the combustor section 22.

The combustor section 22 includes one or more combustors 54 each having one or more fuel nozzles 56. In certain embodiments, the combustor section 22 may have a single annular combustor 54 extending around a central axis of the gas turbine engine 12. However, in some embodiments, the combustor section 22 may include 2, 3, 4, 5, 6, or more combustors 54 spaced circumferentially about the central axis of the gas turbine engine 12. The fuel nozzles 56 receive a compressed air 58 from the compressor section 20 and fuel 60 from one or more fuel supply systems 62, mix the fuel and air, and ignite the mixture to create hot combustion gases 64, which then exit each combustor 54 and enter the turbine section 24.

The turbine section 24 includes one or more turbine stages 66, wherein each turbine stage 66 includes a plurality of turbine blades 68 arranged circumferentially about and coupled to a turbine shaft 70 inside of a turbine casing 72, and a plurality of turbine vanes 74 arranged circumferentially about the turbine shaft 70. The turbine stages 66 may include between 1 and 10 or more turbine stages. Additionally, the turbine stages 66 alternate between sets of the turbine blades 68 and sets of the turbine vanes 74 in the direction of hot combustion gas flow through the turbine section 24. In operation, the hot combustion gases 64 progressively expand and drive rotation of the turbine blades 68 in the turbine stages 66.

The load 26 may include an electrical generator, a machine, or some other driven load. The load 26 may be disposed at the hot end of the gas turbine engine 12 as illustrated in FIG. 1, or the load 26 may be disposed at the cold end of the gas turbine engine 12 (e.g., adjacent the compressor section 20). The exhaust section 28 may include an exhaust duct, exhaust treatment equipment, silencers, or any combination thereof. In some embodiments, the exhaust section 28 may include and/or direct an exhaust flow through a heat exchanger and/or cooling system. For example, the heat exchanger may include a heat recovery steam generator (HRSG) 27 configured to transfer heat from the exhaust gas to water, thereby generating steam to drive a steam turbine 29. By further example, the cooling system may include or exclude one or more coolers 31, such as a direct contact cooler configured to spray a fluid (e.g., a liquid such as water) directly into the exhaust gas for directly cooling the exhaust gas (e.g., exhaust gas from gas turbine engine 12 and/or boiler 95). In some embodiments, the gas treatment system 16 may include dedicated heat exchangers (e.g., heater and/or coolers) to control the temperatures, and thus the coolers 31 may be excluded from the gas turbine system 10. In certain embodiments, the gas turbine system 10 may include a combined cycle power plant having the gas turbine engine 12, the HRSG 27, and one or more steam turbines 29 driven by steam generated by the HRSG 27. The steam turbines 29, similar to the gas turbine engine 12, may be configured to drive electrical generators or other loads.

The control system 14 may include one or more controllers 76, each having a processor 78, memory 80, instructions 82 stored on the memory 80 and executable by the processor 78, and communications circuitry 84 configured to communicate with the gas treatment system 16. The control system 14 is also coupled to various sensors (S), as indicated by element number 86, distributed throughout the gas turbine system 10. For example, the sensors 86 may be coupled to and monitor conditions at the air intake section 18, the compressor section 20, the fuel supply systems 62, the combustors 54 of the combustor section 22, the turbine section 24, the load 26, the exhaust section 28, and the gas treatment system 16. The control system 14 is configured to receive feedback from the sensors 86 to facilitate adjustments of various operating parameters of the gas turbine engine 12, such as the air intake flow, the fuel supply from the fuel supply system 62 to the combustors 54, operation of exhaust treatment equipment in the exhaust section 28, operation of the gas treatment system 16 (e.g., movement of adsorption modules 100 to facilitate alternative period of adsorption and desorption), or any combination thereof. For example, the control system 14 may be configured to move the adsorption modules 100 along a linear path between a first position in a first flow path in a first duct and a second position in a second flow path in a second duct, wherein the adsorption module 100 is configured to adsorb an undesirable gas while positioned in the first position in the first duct and desorb the undesirable gas while positioned in the second position in the second duct. In this manner, the adsorption modules 100 can alternatively adsorb and desorb, and the gas treatment system 16 may stagger the movements of the different adsorption modules 100 to maintain at least one or more adsorption modules 100 in the first duct for adsorption while at least one or more adsorption modules 100 are disposed in the second duct for desorption.

As discussed in further detail below, the gas treatment system 16 is configured to remove and/or capture one or more undesirable gases (e.g., acid gases and/or exhaust emissions gases) from the incoming gas in sorbent materials in the adsorption modules 100. The undesirable gases are intended to cover any gases that may be undesirable in the fuel supply and/or exhaust gas. For example, the undesirable gases may include acid gases present in the fuel supply and the exhaust gases. By further example, the undesirable gases in the exhaust gases may include any exhaust emissions gases typically subject to regulation, including but not limited to, carbon oxides (COx) such as carbon dioxide (CO₂) and carbon monoxide (CO), nitrogen oxides (NOx), sulfur oxides (SOx) such as sulfur dioxide (SO₂), or any combination thereof. The disclosed embodiments are particularly well suited for gas adsorption of CO₂ from the exhaust gas. However, the following discussion is intended to cover each of these examples when referring to undesirable gases.

The gas treatment system 16 may be configured to receive a fluid 15 (e.g., purge gas, steam, etc.) from a fluid supply system 17, which may include one or more components or equipment that generates steam or another suitable fluid (e.g., liquid, gas or vapor) to desorb the undesirable gases from the adsorption modules 100. For example, the fluid supply system 17 may include the HRSG 27 and/or the steam turbine 29, which generate or output steam 96 as the fluid 15 for desorbing the undesirable gases from the adsorption modules 100. By further example, the fluid supply system 17 may include a boiler 95 (e.g., a standalone or external boiler) configured to generate steam 96 from a heat source (e.g., combustion in the boiler 95), wherein the steam 96 can be used as the fluid 15 for desorbing the undesirable gases from the adsorption modules 100. By further example, the fluid supply system 17 may include one or more other fluid supplies or equipment configured to generate steam 96 or another fluid (e.g., purge gas, liquid, or vapor) for use as the fluid 15 for desorbing the undesirable gases from the adsorption modules 100. In certain embodiments, a vacuum system may be used independently and/or in combination with the fluid supply system 17 to facilitate desorption of the undesirable gases from the adsorption modules 100. The vacuum system may include one or more vacuum pumps configured to lower a pressure of the adsorption modules 100 (e.g., lower pressure around the sorbent material), thereby creating a pressure differential to help separate the undesirable gases (i.e., adsorbed gases in the sorbent material) from the adsorption modules 100 and/or withdraw the undesirable gases from the gas treatment system 16. Accordingly, the vacuum system is configured to suction or pull the undesirable gases out of the adsorption modules 100. The vacuum system may be disposed at the respective adsorption modules 100 and/or downstream of the adsorption modules 100.

In operation, an incoming gas (e.g., exhaust gas 94 from turbine section 24, exhaust gas from the boiler 95, fuel from fuel supply system 62, flue gas, etc.) flows through a first flow path in the gas treatment system 16 and one or more of the adsorption modules 100 adsorbs the undesirable gases from the incoming gas, while the fluid 15 (e.g., steam) flows through a second flow path in the gas treatment system 16 and desorbs the undesirable gases from one or more of the adsorption modules 100. The gas exits the gas treatment system 16 as a treated gas 97 (e.g., treated exhaust gas, treated fuel, treated flue gas, etc.) that is lean in (or substantially free of) the undesirable gases, and the fluid 15 exits the gas treatment system 16 as a fluid 98 rich in the undesirable gases. The treated gas 97 may subsequently flow through additional equipment. For example, if the treated gas 97 is a treated exhaust gas or a treated flue gas, then the treated gas 97 may flow through an exhaust stack before discharging into the environment. If the treated gas 97 is a treated fuel gas, then the treated gas 97 may subsequently flow into the combustor section 22 of the gas turbine engine 12.

The gas treatment system 16 may include downstream equipment 99, such as a vacuum system, a fluid separation system, or any combination thereof, downstream from the adsorption modules 100. Again, the fluid 15 (e.g., steam) is used to desorb the undesirable gases (e.g., CO₂) from the adsorption modules 100, followed by further processing in the downstream equipment 99. The vacuum system of the downstream equipment 99 may include the equipment described above. The fluid separation system of the downstream equipment may include flash tanks, absorbers, or other equipment to separate the fluid 15 (e.g., steam) from the desorbed gas (e.g., undesirable gases). The gas treatment system 16 may use the downstream equipment 99 to separate and capture the undesirable gases (e.g., CO₂) from the fluid 15 (e.g., steam), such that the captured gas can be used for other applications. Accordingly, the gas treatment system 16 may be described as a carbon capture adsorption system.

In operation, the gas turbine system 10 receives air into the inlet duct 30 from the air intake section 18 as indicated by arrows 88, the inlet guide vanes 40 are controlled by the actuators 42 to adjust an angular position of the inlet guide vanes 40 for adjusting air flow into the compressor section 20, and the compressor section 20 is configured to compress the air flow being supplied into the combustor section 22. For example, each stage 44 of the compressor section 20 compresses the air flow with a plurality of the blades 46. The compressed air flow 58 then enters each of the combustors 54, where the fuel nozzles 56 mix the compressed air flow with fuel 60 from the fuel supply system 62. The mixture of fuel and air is then combusted in each combustor 54 to generate the hot combustion gases 64, which flow into the turbine section 24 to drive rotation of the turbine blades 68 in each of the stages 66. The rotation of the turbine blades 68 drives rotation of the turbine shaft 70, which in turn drives rotation of the load 26 and the compressor section 20 via a shaft 90 coupled to the load 26 and a shaft 92 coupled to the compressor shaft 48. The turbine section 24 then discharges an exhaust gas 94 into the exhaust section 28 for final treatment and discharge into the environment.

In the illustrated embodiment, the gas turbine system 10 has the gas treatment system 16 coupled to one or more fuel supply systems 62 and the exhaust section 28. However, the gas treatment system 16 also may be coupled to one or more reciprocating piston-cylinder engines, furnaces, boilers, chemical reactors, gasification systems having one or more gasifiers configured to produce a synthesis gas, or other industrial equipment. Each of these gas treatment systems 16 has the features described in further detail below, and the disclosed embodiments are intended to be used in various combinations with one another in all of the foregoing applications.

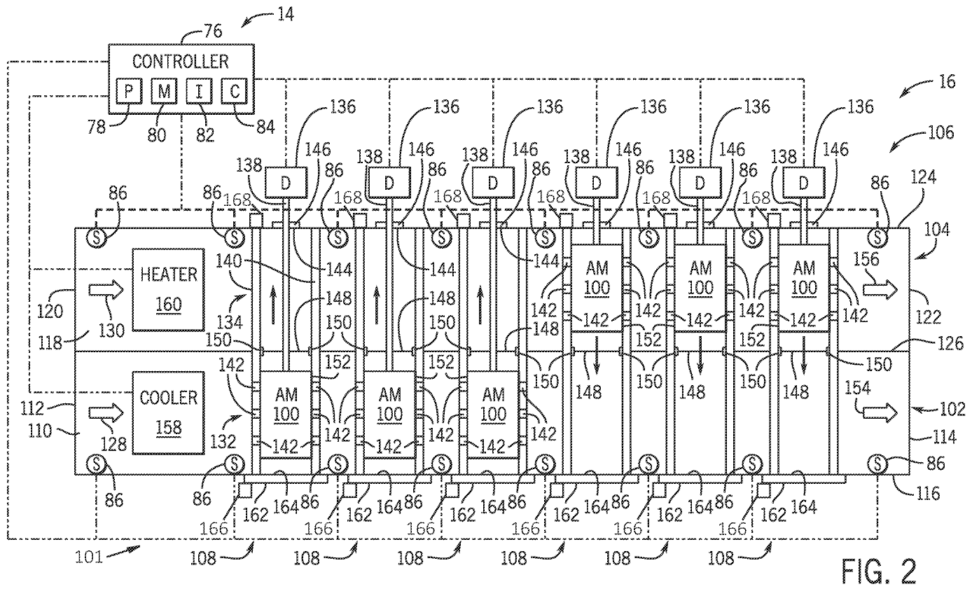

FIG. 2 is a schematic view of an embodiment of the gas treatment system 16 of FIG. 1, further illustrating details of the adsorption modules 100 moving linearly back and forth between ducts 102 and 104. As illustrated, the gas treatment system 16 includes an adsorption system 106 having a plurality of movable adsorption assemblies 108 configured to move the adsorption modules 100 between the ducts 102 and 104. For example, the adsorption system 106 may be configured to move the adsorptions modules 100 in a staggered arrangement in the ducts 102 and 104, such that one or more of the adsorption modules 100 are positioned in the duct 102 for adsorption of undesirable gases while one or more of the adsorption modules 100 are positioned in the duct 104 for desorption of undesirable gases. The adsorption modules 100 may be configured to move crosswise (e.g., perpendicular) to longitudinal axes of the ducts 102 and 104, while also moving parallel to one another (e.g., along parallel paths of travel in linear directions). Various aspects of the adsorption modules 100 are discussed in further detail below.

The adsorption modules 100 may be disposed entirely within the ducts 102 and/or 104 during normal operation of the gas treatment system 16. The duct 102 has a flow path 110 extending lengthwise through the duct 102 between an inlet 112 and an outlet 114, wherein a sidewall 116 of the duct 102 extends about the flow path 110. For example, the sidewall 116 may include a rectangular sidewall defining a rectangular shape of the duct 102. Similarly, the duct 104 has a flow path 118 extending lengthwise through the duct 104 from an inlet 120 to an outlet 122, wherein a sidewall 124 of the duct 104 extends about the flow path 118. For example, the sidewall 124 may define a rectangular sidewall 124 defining a rectangular shape of the duct 104. The ducts 102 and 104 may be disposed directly adjacent to one another (e.g., in contact with one another), such that ducts 102 and 104 have an intermediate wall 126 disposed directly between the flow path 110 of the duct 102 and the flow path 118 of the duct 104. In certain embodiments, the intermediate wall 126 may be a single shared wall between the ducts 102 and 104. However, in some embodiments, the intermediate wall 126 may include the sidewalls 116 and 124 of the ducts 102 and 104. Although the illustrated embodiment depicts linear ducts 102 and 104, the ducts 102 and 104 may have one or more turns, curves, angled portions, or any combination thereof. Additionally, the ducts 102 and 104 may be sized the same or different from one another, and the ducts 102 and 104 may have the same or different shapes. The duct 102 may also be described as an adsorption duct (e.g., adsorbing undesirable gases into sorbent materials of the adsorption modules 100), while duct 104 may be described as a desorption duct 104 (e.g., desorbing undesirable gases from the sorbent materials of the adsorption modules 100). The ducts 102 and 104 may be configured to flow a variety of fluid flows, such as gases, liquids, or multi-phase fluid flows.

In the illustrated embodiment, the duct 102 is configured to receive and pass a fluid flow 128, which may include a fuel, an exhaust gas, or another untreated gas having undesirable gases. For example, the undesirable gases may include carbon oxides (COx) such as carbon dioxide (CO₂) and carbon monoxide (CO), nitrogen oxides (NOx), sulfur oxides (SOx) such as sulfur dioxide (SO₂), hydrogen sulfide (H₂S), or any combination thereof. The duct 104 is configured to receive and pass a fluid flow 130, which may include steam, an inert gas such as nitrogen, air, a vacuum or suction flow, or another fluid flow. As discussed in further detail below, each movable adsorption assembly 108 is configured to move the respective adsorption module 100 between the flow path 110 in the duct 102 and the flow path 118 and the duct 104 to alternatingly adsorb undesirable gases from the fluid flow 128 and desorb the undesirable gases in response to heat added by the fluid flow 130 in the duct 104.

Each movable adsorption assembly 108 has the adsorption module 100 movably coupled to a linear position assembly 132, which extends between and enables movement of the adsorption module 100 from the duct 102 to the duct 104 and vice versa. The linear positioning assembly 132 may include a plurality of rail assemblies 134 coupled to the ducts 102 and 104 and the adsorption module 100. Additionally, the linear positioning assembly 132 includes a drive 136 coupled to a drive line 138, wherein the drive line 138 is coupled to the respective adsorption module 100.

As discussed in further detail below, each rail assembly 134 may include a mating set of a rail 140 and one or more slides 142 configured to move along the rail 140 between the ducts 102 and 104. For example, the slides 142 may include wheels, blocks of low friction material, mating rails, or any combination thereof. In certain embodiments, the rails 140 are coupled to the ducts 102 and 104 and extend all or substantially all of the distance between the sidewalls 116 and 124, while the slides 142 are coupled to each of the adsorption modules 100. In the illustrated embodiment, the linear positioning assembly 132 has rail assemblies 134 disposed on opposite sides of each adsorption module 100. However, the rail assemblies 134 may be disposed on only one side, opposite sides, four corners, or any combination of positions, along each respective adsorption module 100.

The drive line 138 extends between the drive 136 and the adsorption module 100, wherein the drive line 138 may include a rigid bar or rod, a flexible cable, a chain, a rope, or any combination thereof. The drive 136 may include an electric motor, a fluid driven piston cylinder assembly, a combustion engine, a gear assembly, a manual wheel or actuator assembly, or any combination thereof. The drive line 138 may be configured to move linearly, rotate, or any combination thereof, to cause linear motion of the adsorption module 100 along a linear path of travel defined by the rail assemblies 134 of the linear positioning assembly 132 between the duct 102 and the duct 104. The drive line 138 also may extend through the sidewall 124, such as through an opening 144 in the sidewall 124, wherein the drive line 138 may be further supported by a bushing or seal 146 at the sidewall 124. For example, the bushing or seal 146 may be an annular structure configured to seal about the drive line 138 to block leakage of the fluid flow 130 out of the duct 104 into the surrounding environment. In some embodiments, the drive 136 may be disposed in a sealed enclosure along the sidewall 134 and/or inside of the duct 104.

At each linear positioning assembly 132, the adsorption module 100 is configured to move between the ducts 102 and 104 via an opening 148 in the intermediate wall 126. For example, the opening 148 may have a size and shape contoured or similar to an outer perimeter 152 of the adsorption module 100. Additionally, the opening 148 may be surrounded or bordered by a seal 150. For example, as discussed in further detail below, the seal 150 may include a brush seal that contacts the outer perimeter 152 of the adsorption module 100 at all times and positions of the adsorption module 100 as the adsorption module 100 moves between the duct 102 and the duct 104. Accordingly, the interface between the seal 150 and the outer perimeter 152 blocks leakage between the fluid flow 128 in the duct 102 and the fluid flow 130 in the duct 104. As illustrated in FIG. 2, three of the linear positioning assemblies 132 have the adsorption modules 100 disposed in the duct 102, such that the adsorption modules 100 are actively adsorbing the undesirable gases from the fluid flow 128. However, three of the adsorption modules 100 are also disposed in the duct 104, such that the undesirable gases can be desorbed from the adsorption modules 100 for regeneration of the adsorption modules 100 prior to further use in the duct 102. As discussed in further detail below, the gas treatment system 16 is configured to alternate positions of the adsorption modules 100 between the ducts 102 and 104, such that one or more of the adsorption modules 100 are adsorbing undesirable gases in the duct 102 while one or more of the adsorption modules 100 are being regenerated by desorption in the duct 104.

The controller 76 is configured to control movement and positioning of the adsorption modules 100 depending on various parameters, such as rates of adsorption in the duct 102 and rates od desorption in the duct 104. As illustrated in FIG. 2, in the duct 102, the fluid flow 128 treated by the adsorption modules 100 results in adsorption of the undesirable gases, such that the fluid flow 128 becomes treated and generates a treated fluid flow 154 being discharged through the outlet 114 of the duct 102. For example, the treated fluid flow 154 may be entirely or substantially free of the undesirable gases, such as CO₂, H₂S, SO₂, NO₂, or any combination thereof. In the duct 104, the fluid flow 130 provides heat to facilitate desorption of the undesirable gases from the adsorption modules 100. For example, the fluid flow 130 may include steam configured to flow through and around each of the adsorption modules 100 in the duct 104, thereby helping to heat the adsorption modules 100 and cause desorption of the undesirable gases out of the adsorption modules 100 for subsequent capture, cooling, and compression. Thus, the duct 104 discharges a cooled fluid flow 156, such as a cooled steam. In certain embodiments, the undesirable gases desorb from the adsorption modules 100 into the duct 104, which then carries the desorbed gases along with the cooled fluid flow 156 for subsequent capture, cooling, and compression. Alternatively, or additionally, the desorbed gases may be separated and captured at each individual adsorption module 100.

The gas treatment system 16 also may include a thermal control system 101 having one or more temperature control systems, such as one or more coolers 158, one or more heaters 160, a cooling system 166, and a heating system 168. Each of the coolers 158, heaters 160, the cooling system 166, and the heating system 168 may include indirect heat exchangers, direct heat exchangers, or a combination thereof. The indirect heat exchangers transfer heat between two fluids via separate flow paths, such that the two fluids do not contact one another. The direct heat exchangers directly mix and enable contact between the two fluids, such as by injecting, spraying, or otherwise supplying a fluid into another flow path (e.g., water spray, steam spray, etc.). The thermal control system 101 is configured to provide heat transfer, and thus temperature control, at various locations upstream from the movable adsorption assemblies 108, directly at the movable adsorption assemblies 108, in between successive movable adsorption assemblies, or any combination thereof, in the ducts 102 and 104. Additionally, the thermal control system 101 is configured to provide heat transfer between the ducts 102 and 104, such as by transferring heat between one or more heat exchangers in the duct 102 and one or more heat exchangers in the duct 104. As illustrated in FIG. 2, the cooler 158 and the heater 160 are disposed upstream from the movable adsorption assemblies 108; however, the cooler 158 and the heater 160 also may be disposed directly at the movable adsorption assemblies 108, in between successive movable adsorption assemblies 108, and/or fluidly coupled together in a closed-loop heat transfer circuit between the ducts 102 and 104. As further illustrated in FIG. 2, the cooling system 166 and the heating system 168 are disposed directly at the movable adsorption assemblies 108; however, the cooling system 166 and the heating system 168 may be disposed upstream from the movable adsorption assemblies 108, in between successive movable adsorption assemblies 108, and/or fluidly coupled together in a closed-loop heat transfer circuit between the ducts 102 and 104. Thus, each of the coolers 158, heaters 160, the cooling system 166, and the heating system 168 are contemplated for the any or all of the foregoing locations in the following discussion of the drawings.

In the illustrated embodiment, the fluid flow 128 entering the duct 102 may be a heated fluid flow, such as an exhaust gas. One or more coolers 158 may be disposed in the duct 102 upstream of the movable adsorption assemblies 108. The coolers 158 are configured to cool the fluid flow 128 prior to flowing through and/or around the adsorption modules 100. In certain embodiments, if the fluid flow 128 is sufficiently cool or below a threshold temperature, the duct 102 may exclude the coolers 158 and/or the controller 76 may not operate the coolers 158. Additionally, one of the cooling systems 166 may be coupled to each of the moveable adsorption assemblies 108 to provide cooling directly at the respective moveable adsorption assemblies 108. The controller 76 may be configured to control each of the cooling systems 166, thereby providing a suitable temperature of the exhaust gas for adsorption of the undesirable gases at the respective moveable adsorption assembly 108. In certain embodiments, the controller 76 may be configured to activate the cooling system 166 for a particular moveable adsorption assembly 108 only when the adsorption module 100 is disposed in the duct 102 for adsorption of the undesirable gases from the exhaust gas, and then deactivate the cooling system 166 when the adsorption module 100 is disposed in the duct 104 for desorption of the undesirable gases. Additionally, the controller 76 may be configured to provide independent temperature control at each of the moveable adsorption assemblies 108, and particularly the adsorption modules 100, via the cooling systems 166. The independent temperature control may be based on temperature feedback from the sensors 86 at each of the movable adsorption assemblies 108 (e.g., local temperatures upstream, downstream, or directly at the adsorption modules 100).

Similarly, in the duct 104, the fluid flow 130 may be heated by one or more heaters 160 to help raise the temperature of the fluid flow 130 prior to passage through the adsorption modules 100 being regenerated in the duct 104. For example, each heater 160 may be an electric resistance heater, a heat exchanger, or another form of heater configured to raise the temperature high enough to help induce desorption of the undesirable gases from the adsorption modules 100. In certain embodiments, if the fluid flow 130 is sufficiently hot or above a threshold temperature, the duct 104 may exclude the heaters 160 and/or the controller 76 may not operate the heaters 160. Additionally, one of the heating systems 168 may be coupled to each of the moveable adsorption assemblies 108 to provide heating directly at the respective moveable adsorption assemblies 108. The controller 76 may be configured to control each of the heating systems 168, thereby providing a suitable temperature in the sorbent material of the adsorption modules 100 for desorption of the undesirable gases at the respective moveable adsorption assembly 108. In certain embodiments, the controller 76 may be configured to activate the heating system 168 for a particular moveable adsorption assembly 108 only when the adsorption module 100 is disposed in the duct 104 for desorption of the undesirable gases, and then deactivate the heating system 168 when the adsorption module 100 is disposed in the duct 102 for adsorption of the undesirable gases from the exhaust gas. Additionally, the controller 76 may be configured to provide independent temperature control at each of the moveable adsorption assemblies 108, and particularly the adsorption modules 100, via the heating systems 168. The independent temperature control may be based on temperature feedback from the sensors 86 at each of the movable adsorption assemblies 108 (e.g., local temperatures upstream, downstream, or directly at the adsorption modules 100).

The gas treatment system 16 also may include maintenance features to help inspect, repair, service, change, or otherwise modify the adsorption modules 100 in each of the movable adsorption assemblies 108. Accordingly, each of the movable adsorption assemblies 108 may include an access panel 162 removably coupled to the sidewall 116 over an access opening 164 aligned with the linear positioning assembly 132 and the respective adsorption module 100. Accordingly, as discussed in further detail below, the access panel 162 may be removed to allow visual inspection and/or removal of the adsorption module 100 through the access opening 164. The access panels 162 may include hinged doors, bolted doors, metal panels, glass or otherwise clear panels to facilitate viewing, or any combination thereof.

As further illustrated, the control system 14 has the controller 76 coupled to each of the drives 146 of the linear positioning assemblies 132, each component of the thermal control system 101 (e.g., the one or more coolers 158, the one or more heaters 160, the cooling system 166, and the heating system 168), and a plurality of sensors 86 disposed throughout each of the ducts 102 and 104. As discussed above with reference to FIG. 1, each of the sensors is designated with an S, and thus the sensors are not all numbered in the illustrated embodiment. However, each of the sensors 86 may be disposed upstream and/or downstream of each of the illustrated components, such as the adsorption modules 100, the cooler 158, and the heater 160 in each of the ducts 102 and 104. The sensors 86 may include temperature sensors, flow rate sensors, pressure sensors, fluid composition sensors, or any combination thereof. For example, the sensors 86 may include gas composition sensors configured to monitor the rate of adsorption of the undesirable gases from the adsorption modules 100 disposed in the duct 102, and to monitor the rate of desorption of the undesirable gases from the adsorption modules 100 disposed in the duct 104.

The rate of adsorption or desorption of the undesirable gases may help to facilitate control by the controller 76 of the movement of the adsorption modules 100 between the duct 102 and the duct 104. For example, if the adsorption rate gradually reduces to a level below a threshold adsorption rate, then the controller 76 may be configured to operate the drive 136 to move the adsorption module 100 from the duct 102 to the duct 104, such that the adsorption module 100 can undergo regeneration by desorbing the undesirable gases from the adsorption module 100 via the fluid flow 130. Similarly, if the desorption rate in the duct 104 gradually reduces to a level below a threshold desorption rate, then the controller 76 may be configured to operate the drive 136 to move the adsorption module 100 from the duct 104 to the duct 102, such that the adsorption module 100 can function to adsorb the undesirable gases from the fluid flow 128 in the duct 102. Accordingly, the sensor feedback from the sensors 86 may facilitate control by the controller 76 to cycle the adsorption modules 100 back and forth between the ducts 102 and 104 to ensure there are always one or more adsorption modules 100 efficiently adsorbing the undesirable gases in the duct 102 while the other adsorption modules 100 are being regenerated in the duct 104.

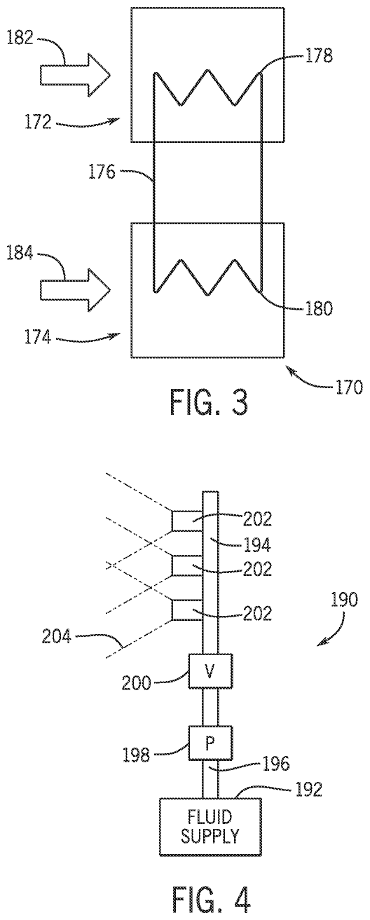

The controller 76 also may be configured to control the temperature in each of the ducts 102 and 104 via control of the cooler 158, the heater 160, the cooling systems 166, and the heating systems 168 of the thermal control system 101. For example, the controller 76 may be configured to control the cooler 158 and/or the cooling systems 166 to adjust or maintain the temperature in the duct 102 and/or individual adsorption units 100 at or below a threshold temperature, while the controller 76 may be configured to control the heater 160 and/or the heating systems 168 to adjust or maintain the temperature in the duct 104 and/or individual adsorption units 100 at or above a threshold temperature. Further details of the adsorption modules 100, the movable adsorption assemblies 108, the cooler 158, the heater 160, the cooling system 166, and the heating system 168 are discussed in further detail below with reference to FIGS. 3-20.

FIG. 3 is a schematic view of an embodiment of a temperature control system 170 (e.g., indirect heat exchange system) configured to provide temperature control for the cooler 158, the heater 160, the cooling system 166, and/or the heating system 168 of FIG. 2. For example, the temperature control system 170 may include a heat exchanger 172, a heat exchanger 174, and a fluid circuit 176 (e.g., heat transfer circuit) extending between and through the heat exchangers 172 and 174. For example, the fluid circuit 176 may include a plurality of coils or winding tubes 178 in the heat exchanger 172 and a plurality of coils or winding tubes 180 in the heat exchanger 174. The fluid circuit 176 may be configured to circulate a heat transfer fluid or working fluid, such as water, oil or lubricant, a refrigerant, or any combination thereof. In certain embodiments, the temperature control system 170 may have the heat exchangers 172 and 174 and the fluid circuit 176 arranged or configured as a heat pump cycle or refrigeration cycle, such as a vapor-compression cycle or a vapor absorption cycle. Thus, the fluid circuit 176 may further include an expansion valve and a compressor to complete the heat pump cycle or refrigeration cycle. The refrigerant may include, for example, R-32, HFC-32, or difluoromethane (CH₂F₂); R-134a, HFC-134a, or 1,1,1,2-tetrafluoroethane (CF₃CH₂F); R-410a or pentafluoroethane (CF₃CHF₂); R-290 or propane (C₃H₈); R-600a or isobutane (HC(CH₃)₃); R-717 or ammonia (NH₃); R-744 or carbon dioxide (CO₂); R-1234yf, HFO-1234yf, or 2,3,3,3-Tetrafluoropropene (C₃H₂F₄); or any combination thereof.

In the illustrated embodiment, the temperature control system 170 may be configured to transfer heat between a relatively lower temperature fluid flow 182 passing through the heat exchanger 172 and a relatively higher temperature fluid flow 184 passing through the heat exchanger 174. The fluid circuit 176 circulates a working fluid through the coils or tubes 178 and 180 in the heat exchangers 172 and 174, such that heat can be transferred between the relatively lower and higher temperature fluid flows 182 and 184. For example, the lower temperature fluid flow 182 is configured to transfer heat away from the working fluid in the coils or tubes 178, while the higher temperature fluid flow 184 is configured to transfer heat into the working fluid in the coils or tubes 180. Accordingly, the heat exchanger 172 also may be described as a heater, because the heated working fluid passing through the coils or tubes 178 causes an increase and temperature of the lower temperature fluid flow 182. The heat exchanger 174 may be described as a cooler, because the relatively cooler working fluid in the coils or tubes 180 is configured to cool or lower the temperature of the higher temperature fluid flow 184. In certain embodiments, the temperature control system 170 may be configured as a heat pump, wherein the heat exchanger 172 is a condenser configured to cool and condense the working fluid in the fluid circuit 176 and heat the fluid flow 182, and the heat exchanger 174 is an evaporator configured to heat and evaporate the working fluid in the fluid circuit 176 and cool the fluid flow 184. In the foregoing embodiment (e.g., heat pump), the fluid circuit 176 may further include an expansion valve downstream from the heat exchanger 172 (e.g., condenser) and upstream from the heat exchanger 174 (e.g., evaporator), and the fluid circuit 176 may include a compressor downstream from heat exchanger 174 (e.g., evaporator) and upstream from heat exchanger 172 (e.g., condenser).

In certain embodiments, the temperature control system 170 may be disposed in the gas treatment system 16 in a variety of ways. For example, the heat exchanger 172 may correspond to the heater 160 while the heat exchanger 174 corresponds to the cooler 158, such that the entire temperature control system 170 is disposed within the ducts 102 and 104. Alternatively, or additionally, the heat exchanger 172 may be disposed in the duct 104 as the heater 160, while the heat exchanger 174 is disposed outside of the gas treatment system 16 in the path of a completely different higher temperature fluid flow 184. Similarly, the heat exchanger 174 may be disposed in the duct 102 and serve as the cooler 158, while the heat exchanger 172 may be disposed completely outside of the gas treatment 16 within a lower temperature fluid flow 182 separate from the gas treatment system 16. However, a variety of the foregoing configurations may be used alone or in combination with one another, as well as combinations with other types of coolers 158 and heaters 160.

In certain embodiments, the temperature control system 170 may use the heat exchangers 172 and 174 in association with the cooling system 166 and the heating system 168. For example, the heat exchanger 172 may correspond to the heating system 168 while the heat exchanger 174 corresponds to the cooling system 166, such that the entire temperature control system 170 is disposed within the ducts 102 and 104 at one or more of the movable adsorption assemblies 108. Alternatively, or additionally, the heat exchanger 172 may be disposed in the duct 104 as the heating system 168, while the heat exchanger 174 is disposed outside of the gas treatment system 16 in the path of a completely different higher temperature fluid flow 184. Similarly, the heat exchanger 174 may be disposed in the duct 102 and serve as the cooling system 166, while the heat exchanger 172 may be disposed completely outside of the gas treatment 16 within a lower temperature fluid flow 182 separate from the gas treatment system 16.

FIG. 4 is a schematic of an embodiment of a direct heat exchange system 190 configured to provide heating or cooling depending on the configuration of the system 190. For example, the illustrated direct heat exchange system 190 includes a fluid supply 192, a fluid distribution manifold 194, and a conduit 196 extending between the fluid supply 192 and the distribution manifold 194. The fluid conduit 196 may also include one or more flow control features, such as a fluid pump 198 and a fluid control valve 200. The fluid pump 198 is configured to pump a fluid flow from the fluid supply 192, while the fluid control valve 200 can be moved between open and closed valve positions to adjust a flow rate of the fluid flow from the fluid supply 192. Collectively, the fluid pump 198 and the fluid control valve 200 are configured to control fluid flow from the fluid supply 192 to the fluid distribution manifold 194. The fluid distribution manifold 194 also may include a plurality of fluid nozzles 202 configured to output a spray 204 of fluid from the fluid supply 192. For example, the fluid supply 192 may include a liquid or gas at a desired temperature to provide heating or cooling directly in the fluid flow 128 or the fluid flow 130 of the gas treatment system 16. Accordingly, the direct heat exchange system 190 may be configured as the cooler 158 and/or the cooling system 166 by injecting a relatively lower temperature fluid into the fluid flow 128. Similarly, the direct heat exchanger system 190 may be configured as the heater 160 and/or the heating system 168 by injecting a relatively higher temperature fluid flow into the fluid flow 130. The fluid supply 192 may include water, inert gas such as nitrogen, air, steam, or another suitable gas or liquid. In certain embodiments, the injection location may be disposed upstream from the movable adsorption assemblies 108 having the adsorption modules 100, directly at the movable adsorption assemblies 108 having the adsorption modules 100, between successive movable adsorption assemblies 108 having adsorption modules 100, or any combination thereof. Additionally, the direct heat exchange system 190 may be used alone or in combination with the temperature control system 170 (e.g., indirect heat exchange system) of FIG. 3 and various components of the thermal control system 101 as discussed in further detail below.

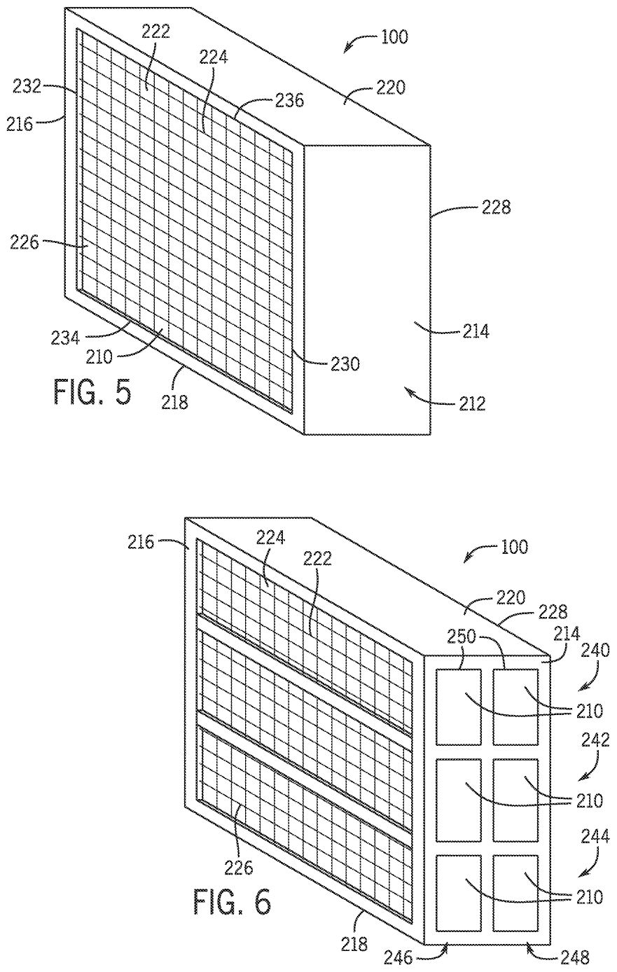

FIG. 5 is a perspective view of an embodiment of the adsorption module 100 of FIGS. 1 and 2. As illustrated, the adsorption module 100 includes a sorbent cartridge 210 disposed in a framework 212. The framework 212 includes sidewalls 214, 216, 218, and 220, which may collectively define a rectangular panel structure of the framework 212. For example, the sidewalls 214 and 216 may be flat rectangular panels that are parallel to one another, while the sidewalls 218 and 220 may be flat rectangular panels that are parallel to one another and perpendicular to the sidewalls 214 and 216. The sidewalls 214 and 216 or the sidewalls 218 and 220 also may couple to the slides 142 of the rail assembly 134 as discussed above with reference to FIG. 2.

The sorbent cartridge 210 may include a sorbent material 212 surrounded and contained by a screen 224. The sorbent material 212 may include a plurality of sorbent particles, beads, balls, strips, or discrete elements of equal or different sizes and shapes. The screen 224 may have a wire mesh with sufficiently small openings to hold the sorbent material 212 while enabling fluid flow along the flow paths 110 and 118. In certain embodiments, the screen 224 extends along opposite upstream and downstream sides 226 and 228 of the sorbent cartridge 210, around lateral sides 230, 232, 234, and 236, or any combination thereof. Thus, the screen 224 enables relatively free flow of the fluid flow 128 or the fluid flow 130 through the sorbent material 222 held in place by the screen 224. In some embodiments, the screen 224 may be disposed only along the upstream and downstream sides 226 and 228, while a solid sidewall may be disposed along the lateral sides 230, 232, 234, and 236 of the sorbent cartridge 210.

Additionally, in certain embodiments, the sorbent cartridge 210 may be removable from the framework 212 for replacement or servicing as needed during operation of the gas treatment system 16. For example, the sorbent cartridge 210 may be removable from the upstream side 226 and/or the downstream side 228 of the framework 212. Although the embodiment of FIG. 5 shows one sorbent cartridge 210, embodiments of the adsorption module 100 may include any number and configuration of sorbent cartridges 210, which may be removably disposed within the framework 212.

FIG. 6 is a perspective view of an embodiment of the adsorption module 100 having a plurality of sorbent cartridges 210 disposed within the framework 212. The features of the sorbent cartridge 210 are substantially the same as discussed above with reference to FIG. 5. However, the embodiment of FIG. 6 has a plurality of smaller sorbent cartridges 210 arranged in rows 240, 242, and 244, and columns 246 and 248. The column 248 is disposed along the upstream side 226, while the column 248 is disposed along the downstream side 228. The illustrated sorbent cartridges 210 may be sized and configured substantially the same as one another. However, in some embodiments, the adsorption module 100 may have a plurality of differently sized and configured sorbent cartridges 210, which may include different dimensions, different sorbent materials 222, different screen arrangements of the screens 224, or any combination thereof. As illustrated, the adsorption module 100 has three rows 240, 242, and 244; however, the adsorption module 100 may have any number of rows (e.g., 1, 2, 3, 4, 5, 6, 7, 8, 9, 10, or more rows). Similarly, the illustrated adsorption module 100 has two columns 246 and 248; however, the adsorption module 100 may have any number of columns (e.g., 1, 2, 3, 4, 5, 6, 7, 8, 9, 10, or more columns).

In the illustrated embodiment, the framework 212 includes a plurality of cartridge openings 250 disposed in the sidewall 214, such that each of the sorbent cartridges 210 may be inserted and removed through one of the cartridge opening 250 of the framework 212. Accordingly, the adsorption module 100 includes the cartridge openings 250 to facilitate easy inspections, servicing, replacements, and other maintenance actions for each of the sorbent cartridges 210 independently from one another. Additionally, the entire adsorption module 100, such as the adsorption modules 100 of FIGS. 5 and 6, may be configured to be inserted and removed through the access openings 164 of the duct 102 as discussed above with reference to FIG. 2.

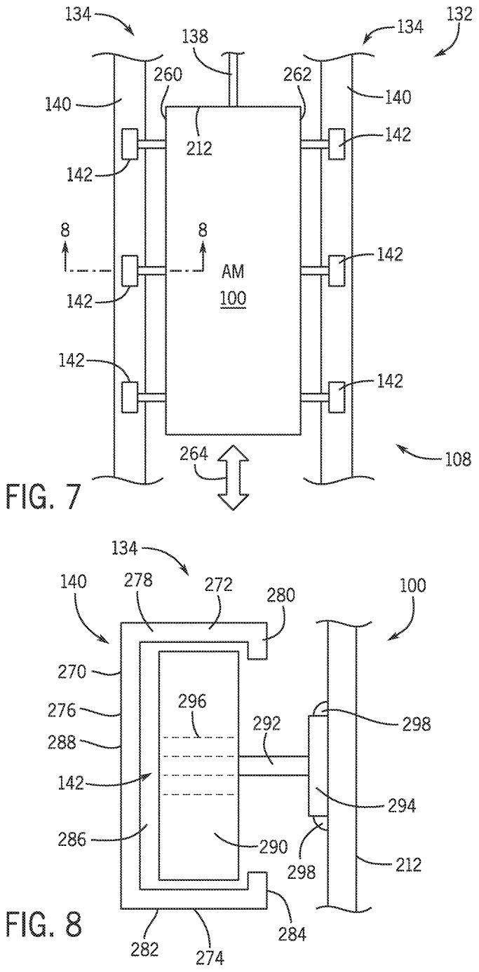

FIG. 7 is a partial schematic view of an embodiment of one of the movable adsorption assemblies 108 as illustrated in FIG. 2. In the illustrated embodiment, the movable adsorption assembly 108 has the adsorption module 100 slidingly disposed along the linear positioning assembly 132 via rail assemblies 134 disposed on opposite sides 260 and 262 of the adsorption module 100. For example, each side 260 and 262 of the adsorption module 100 may have one or more slides 142, which are configured to slide or move along the corresponding rails 140 in a linear direction as indicated by arrow 264 (e.g., a linear path of travel). The opposite sides 260 and 262 may correspond to any of the opposite sides discussed above with reference to FIGS. 5 and 6. For example, the opposite sides 260 and 262 may correspond to the upstream and downstream sides 226 and 228, the sidewalls 214 and 216, or the sidewalls 218 and 220 of the framework 212. In some embodiments, each of the opposite sides 260 and 262 of the adsorption module 100 may have a plurality of the rail assemblies 134, such as rail assemblies 134 disposed along the corners or edges of the opposite sides 260 and 262, one or more intermediate locations along the sides 260 and 262, or a combination thereof. The illustrated rail assemblies 134 have three slides 142 disposed in each rail 140 on each of the sides 260 and 262. However, certain embodiments of the rail assemblies 134 may include 2, 3, 4, 5, 6, 7, 8, 9, 10, or more slides 142 disposed in each of the rails 140.

The slides 142 may include rotatable wheels, blocks of low friction material, or a combination thereof. For example, the blocks of low friction material may include low friction metals or metal coatings, low fiction plastics or plastic coatings, low friction ceramics or ceramic coatings, nylon, polytetrafluoroethylene (PTFE), diamond-like carbon (DLC) coatings, or any combination thereof. The slides 142 also may be partially or entirely captured within each of the rails 140, such that the slides 142 cannot become dislodged from the rails 140 when moving the adsorption module 100 in the linear direction 264. Additionally, as discussed above, the rails 140 generally extend an entire distance across each of the ducts 102 and 104, such that the rail assemblies 134 enable movement of the adsorption module 100 entirely into one of the ducts 102 or 104. Additional details of the rail assemblies 134 are discussed in further detail below.

FIG. 8 is a partial cross-sectional view of an embodiment of the rail assembly 134 of FIGS. 2 and 7, further illustrating details of the engagement between the rails 140 and the slides 142. As illustrated, the rail 140 may include a C-shaped cross-section 270 having upper and lower walls 272 and 274 coupled together via a sidewall 276. For example, the upper wall 272 may include a flat plate 278 having a radially inward lip 280, while the lower wall 274 may have a flat plate 282 with a radially inward lip 284. For example, the flat plates 278 and 282 may be substantially parallel to one another, while the radially inward lips 280 and 284 may be protruding inwardly toward one another about an interior channel 286. The sidewall 276 also may include a flat plate 288 coupled to the flat plates 278 and 282. The C-shaped cross-section 270 extends linearly in the linear direction 264 as indicated in FIG. 7, such that the slide 142 is able to move along the interior channel 286 between the flat plates 278 and 282 of the upper and lower walls 272 and 274. Additionally, the radially inward lips 280 and 284 are configured to block the slide 142 from inadvertently moving out of the C-shaped cross-section 270 of the rail 140.

As discussed above, the slide 142 may be configured as a rigid low friction sliding material, a rotatable wheel, or a combination thereof. In the illustrated embodiment, the slide 142 has a wheel 290 rotatably coupled to a shaft 292, which in turn is coupled to the framework 212 of the adsorption module 100 via a mount 292. The wheel 290 also may include a bearing 296 disposed about the shaft 292, thereby helping to facilitate rotation of the wheel 290 about the shaft 292. The mount 294 may be configured to fixedly or removably couple to the framework 212. For example, the mount 294 may be welded to the framework 212 via one or more welded joints 298. In some embodiments, the wheel 290 may represent a block of low friction material to facilitate sliding along the rail 140, such as a low friction metal, plastic, ceramic, or other suitable material.

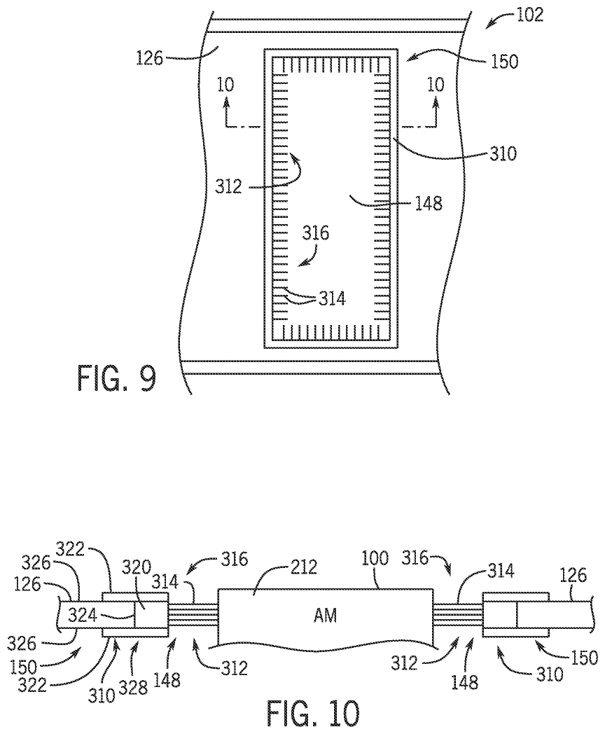

FIG. 9 is a schematic view of an embodiment of the moveable adsorption assembly 108 of FIG. 2, further illustrating details of the seal 150 disposed about the opening 148 in the intermediate wall 126 between the first and second ducts 102 and 104. The opening 148 and the seal 150 facilitate movement of the adsorption module 100 between the duct 102 and the duct 104 as discussed above with reference to FIG. 2. As illustrated, the opening 142 is a rectangular shaped opening contoured to the rectangular shape of the adsorption module 100. The seal 150 is disposed about the perimeter of the opening 148.

In certain embodiments, the seal 150 may include a seal frame or border 310 disposed about the opening 148, and a flexible seal material 312 disposed along the seal frame or border 310. For example, the seal frame or border 310 may have a rectangular shape contoured or matched to the rectangular shape of the opening 148, and the flexible seal material 312 may include flexible metal, plastic, rubber, or other materials depending on the temperatures of the fluid flow 128 and the fluid flow 130. For example, in certain embodiments, the flexible seal material 312 may include a plurality of fibers 314 of a brush seal 316. Accordingly, the bush seal 316 may include a plurality of closely spaced fibers 314 made of the flexible seal material 312 to facilitate a dynamic seal as the adsorption module 100 moves through the opening 148 between the duct 102 and the duct 104.

Regardless of the position of the adsorption module 100, the seal 150 is configured to maintain a seal along the framework 212 of the adsorption module 100 to help block leakage of the fluid flows 128 and 130 between the ducts 102 and 104. In some embodiments, the seal 150 may include a plurality of different types of seals, such as the brush seal 316 having the fibers 314, metal seals, plastic seals, rubber seals, fabric seals, or any combination thereof. The seal 150 may include a single continuous strip of the flexible seal material 312, discrete pieces of the flexible seal material 312 (e.g., fibers 314 of the brush seal 316), overlapping flaps of the flexible seal material 312, or any combination thereof.

FIG. 10 is a partial cross-sectional view of the movable adsorption assembly 108 taken along line 10-10 of FIG. 9, further illustrating the adsorption module 100 sealed against the seal 150 within the opening 148 of the intermediate wall 126. As illustrated, the seal 150 has the fibers 314 of the brush seal 316 disposed against and in contact with the framework 212 of the adsorption module 100. The fibers 314 are coupled to and supported by the seal frame or border 310, which includes an edge wall 320 and opposite sidewalls 322. The edge wall 320 is configured to extend along an inner edge 324 of the opening 148, while the sidewalls 322 are configured to extend along opposite side surfaces 326 of the intermediate wall 126. Collectively, the edge wall 320 and the opposite side walls 322 define a C-shaped structure 328, which is configured to be self-retained about the intermediate wall 126 at the opening 148. However, in certain embodiments, the C-shaped structure 328 of the seal frame or border 310 may be further coupled to the intermediate wall 126 via fixed joints, removable fasteners, or a combination thereof. For example, the fixed joints may include welded joints, brazed joints, or integrally formed structures. The removable fasteners may include threaded bolts, clamps, springs or hooks, dovetail joints, or any combination thereof.

Again, the illustrated seal 150 has the fibers 314 of the brush seal 316 coupled to the seal frame or border 310. As illustrated, the fibers 314 are directly coupled to the edge wall 320. As the adsorption module 100 moves along the linear positioning assembly 132 between the duct 102 and the duct 104, the fibers 314 of the brush seal 316 are configured to provide sealing between the intermediate wall 126 and the adsorption module 100. In other embodiments, the fibers 314 may be replaced or supplemented with other sealing features, such as flexible flaps, flexible gaskets, or any combination thereof. These flexible flaps or gaskets may be made of flexible metals, plastics, or other materials.

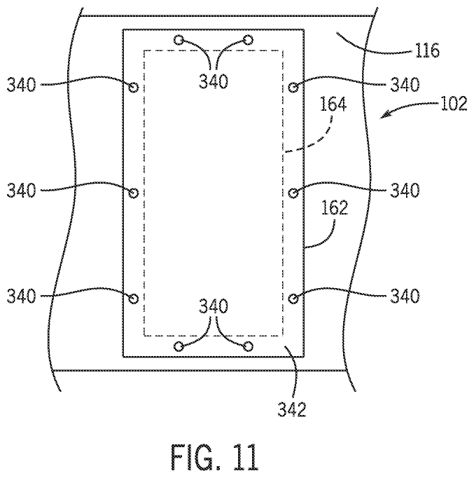

FIG. 11 is a schematic view of an embodiment of the moveable adsorption assembly 108 of FIG. 2, further illustrating details of the access panel 162 disposed over the access opening 164 in the sidewall 116 of the duct 102 to enable insertion and removal of the adsorption module 100. In the illustrated embodiment, the access panel 162 is a rectangular shaped panel disposed over the access opening 164, which also may be a rectangular shaped access opening. The access panel 162 is removably coupled to the sidewall 116 of the duct 102 via a plurality of fasteners 340. For example, the fasteners 340 may include threaded bolts, threaded nuts, threaded shafts, clips, clamps, rotatable latches, hinges, or any combination thereof. Details of the fasteners 340 will be discussed in further detail below. The fasteners 340 are disposed about a border or flange 342 of the access panel 162, wherein the border or flange 342 extends or overlaps with a portion of the sidewall 116 outside of the access opening 164. The fastener 340 may be loosened, removed, or adjusted to enable removal or movement of the access panel 162 away from the access opening 164, thereby enabling access to inspect, insert, or remove the adsorption module 100 relative to the interior of the duct 102 as shown in FIG. 2.

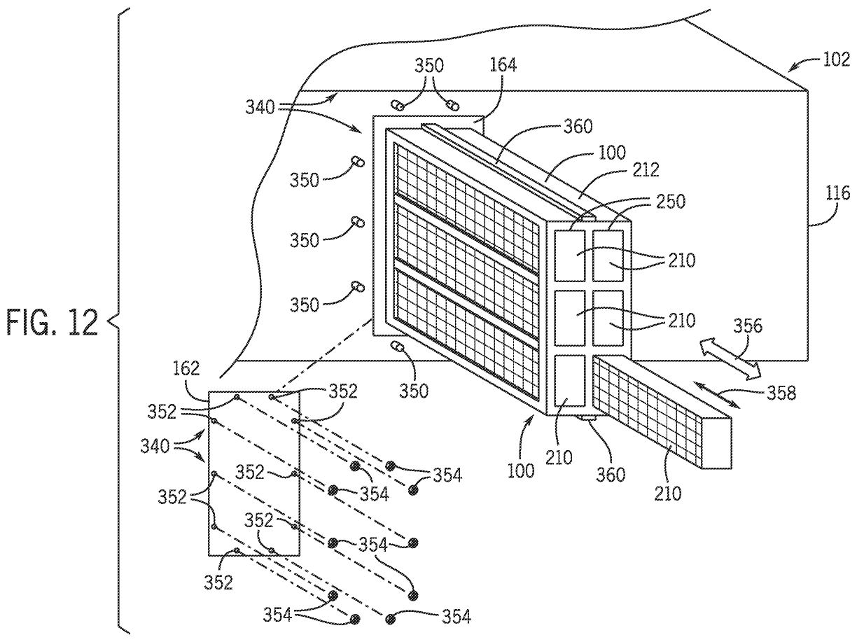

FIG. 12 is a partial perspective view of an embodiment of the gas treatment system 16 of FIG. 2, further illustrating details of the adsorption module 100 partially removed and protruding from the sidewall 116 of the duct 102 via the access opening 164. As illustrated, the access panel 162 is removed from the access opening 164, thereby exposing the access opening 164 and enabling the removal of the adsorption module 100. The fasteners 340 may include a plurality of threaded shafts 350 coupled to the sidewall 116, while the access panel 162 includes a plurality of shaft openings 352 to receive the threaded shafts 350. The fasteners 340 also may include a plurality of threaded nuts 354 configured to couple with the threaded shafts 350 on the exterior of the access panel 162, thereby removably securing the access panel 162 to the sidewall 116. In the illustrated embodiment, the access panel 162 and the threaded nuts 354 are removed from the duct 102, thereby allowing access and removal of the adsorption module 100 from the duct 102.

The linear positioning assembly 132 enables the adsorption module 100 to slide linearly out of the duct 102 as indicated by arrow 356, while the cartridge openings 250 in the framework 212 of the adsorption module 100 enable each of the sorbent cartridges 210 to be inserted and removed as indicated by arrow 358. For example, each of the adsorption modules 100 may be independently accessed via the respective access panels 162 and access openings 164 as illustrated in FIG. 2, while the remaining adsorption modules 100 may continue to operate in either the duct 102 or the duct 104. While one of the adsorption modules 100 is being inspected, removed, installed, or replaced as illustrated in FIG. 12, one or more of the sorbent cartridges 210 also may be independently accessed and moved via the cartridge openings 250. For example, each of the individual sorbent cartridges 210 can be linearly moved out of the cartridge openings 250, inspected, replaced, and reinstalled back into the respective cartridge openings 250. As further illustrated in FIG. 12, each of the rail assemblies 134 may include a rail extension 360, which is configured to extend outwardly from the sidewall 116 when withdrawing the adsorption module 100 from the duct 102. When installing the adsorption module 100 back into the duct 102, the rail extension 360 may slide back into the interior of the duct 102.

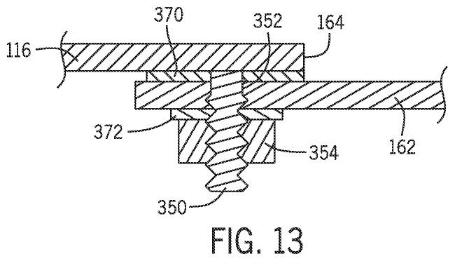

FIG. 13 is a partial cross-sectional view of an embodiment of the access panel 162 coupled to the sidewall 116 of the duct 102 at the access opening 164 as illustrated in FIG. 12. In the illustrated embodiment, the threaded shaft 350 is protruding outwardly from the sidewall 116, the access panel 162 is disposed about the threaded shaft 350 via the shaft opening 352, and the threaded nut 354 is threaded onto the threaded shaft 350 to compressively secure the access panel 162 onto the sidewall 116. In the illustrated embodiment, the access panel 162 may be sealed relative to the sidewall 116 via a flat seal or gasket 370 disposed between the access panel 162 and the sidewall 116. Additionally, the threaded nut 354 may be secured to the threaded shaft 350 with an intermediate washer 372 (e.g., a lock washer) between the threaded nut 354 and the access panel 162. For example, the washer 372 may be a conical shaped washer or Belleville washer, a wave washer, a split or spring lock washer, a toothed lock washer, or any combination thereof.

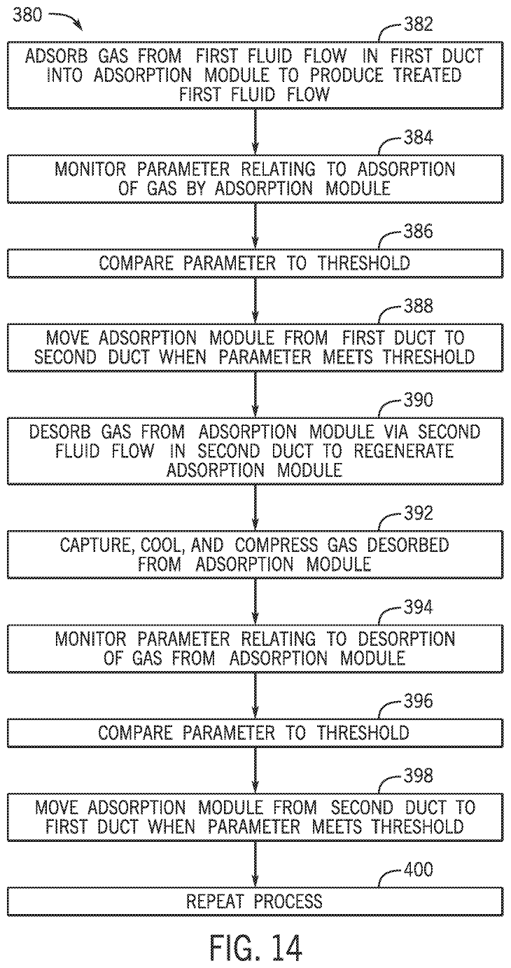

FIG. 14 is flow chart of an embodiment of a process 380 for treating gas in a system, such as the gas treatment system 10 of FIG. 1. The gas treatment may correspond to fuel gas treatment, exhaust gas treatment, or other gas treatments to remove one or more undesirable gases as discussed in detail above. For example, the undesirable gases may include CO₂, H₂S, SO₂, NO₂, or any combination thereof. In the illustrated embodiment, the process 380 may include adsorbing a gas from a first fluid flow 128 in a first duct 102 into an adsorption module 100 to produce a treated first fluid flow 154 as indicated by block 382. The adsorption may include adsorption into one or more sorbent cartridges 210 of the adsorption modules 100 as discussed in detail above. The process 380 may then continue to monitor one or parameters relating to the adsorption of the gas by the adsorption module 100 as indicated by block 384. For example, the process 380 may monitor the various sensors 86 disposed throughout the gas treatment system 16, such as monitoring temperatures, pressures, flow rates, gas compositions of the undesirable gases, rates of change in the adsorption, or any combination thereof. The process 380 may then proceed to compare the parameters to one or more thresholds as indicated by block 386. For example, the process 380 may include comparing an adsorption rate to a threshold adsorption rate. The threshold adsorption rate may indicate that the adsorption module 100 needs to be regenerated to remove the undesirable gases adsorbed into the sorbent material 222 of the sorbent cartridges 210.

The process 380 may then proceed to move the adsorption module 100 from the first duct 102 to the second duct 104 when the parameter meets the threshold as indicated by block 388. Accordingly, the movable adsorption assembly 108 facilitates the movement between the first duct 102 and the second duct 104, such as by moving the adsorption module 100 along the rail assemblies 134 of the linear positioning assembly 132. In particular, the process 380 moves the adsorption module 100 along a linear path of travel defined by the rail assemblies 134, such as perpendicular to longitudinal axes of the ducts 102 and 104.

The process 380 may then proceed to desorb the gas from the adsorption module 100 via a second fluid flow 130 in the second duct 104 to regenerate the adsorption module 100 as indicated by block 390. As discussed above, the regeneration in the second duct 104 may include flowing a heated fluid, such as steam, through and or around the adsorption module 100 to increase the temperature of the sorbent material 222 and help to desorb the undesirable gas from the sorbent cartridges 210 into the fluid flow 130. The process 380 may then proceed to capture, cool, and compress the gas desorbed from the adsorption module 100 as indicated by block 392. The undesirable gas desorbed from the adsorption module 100 may be captured directly at each respective adsorption module 100, in a subsequent process downstream from the adsorption module 100, or by another technique. The cooling also may facilitate separation of the fluid flow 130 from the desorbed gas, such as by condensing a flow of steam to allow separation of the desorbed gas in the duct 104. Additionally, the captured gas may pass through one or more heat exchangers, compressors, or other treatment systems before being routed into storage or a pipeline.

The process 380 may also monitor one or more parameters relating to desorption of the gas from adsorption module 100 as indicated by block 394. For example, the process 380 may monitor the temperature, flow rate, gas composition, or the rate of desorption of the gas from the adsorption module 100. The process 380 may then compare the one or more parameters to corresponding thresholds as indicated by block 396. The comparison in block 396 may include comparing a rate of desorption to a threshold rate of desorption, such that a sufficiently low rate of desorption may trigger the process 380 to move the adsorption module 100 from the second duct 104 to the first duct 102 when the parameter meets the threshold as indicated by block 398. The process 380 may then repeat the process as indicated by block 400. Accordingly, the process 380 may repeatedly cycle or move the adsorption module 100 back and forth between the duct 102 and the duct 104, thereby enabling adsorption of the undesirable gas into the adsorption module 100 in the duct 102 and desorption of the undesirable gas from the adsorption module 100 in the duct 104.

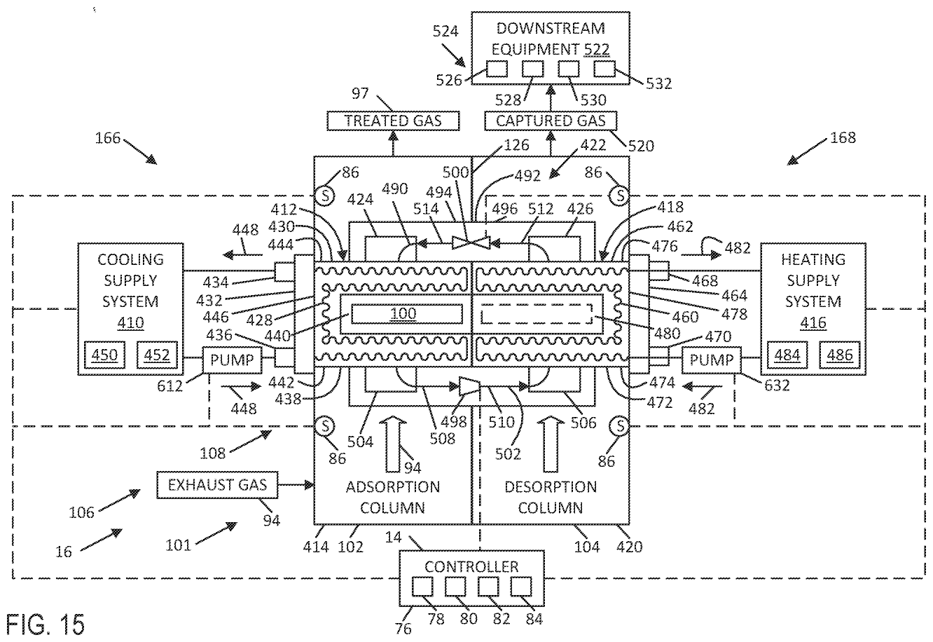

FIG. 15 is a schematic of an embodiment of the gas treatment system of FIGS. 1-14, further illustrating details of the thermal control system 101 having the cooling system 166 and the heating system 168 as discussed above with reference to FIG. 2. The illustrated gas treatment system 16 has the adsorption system 106 of FIG. 2, wherein one of the movable absorption assemblies 108 is illustrated for simplicity. However, the adsorption system 106 of FIG. 15 may include any number (e.g., 1 to 10 or more) of the movable adsorption assemblies 108, such as six movable adsorption assemblies 108 as shown in FIG. 2. Accordingly, the illustrated embodiment of FIG. 15 is merely used to show details of one of the movable adsorption assemblies 108, specifically aspects of thermal control system 101. The illustrated features of FIG. 15 may be a part of the gas treatment system 16 of all other drawings and embodiments described herein.

The cooling system 166 may include a cooling supply system 410 coupled to a heat exchanger 412 disposed in the duct 102 of an adsorption unit 414 of the adsorption system 106. Similarly, the heating system 168 may include a heating supply system 416 coupled to a heat exchanger 418 disposed in the duct 104 of a desorption unit 420 of the adsorption system 106. The illustrated heat exchangers 412 and 418 are separate from one another, such as separated by the intermediate wall 126 disposed between the ducts 102 and 104 of the respective adsorption unit 414 and the desorption unit 420. The thermal control system 101 also may include a heat exchange system 422 having a heat exchanger 424 disposed in the duct 102 of the adsorption unit 414 and a heat exchanger 426 disposed in the duct 104 of the desorption unit 420. The heat exchange system 422 is configured to exchange heat between the duct 102 of the adsorption unit 414 and the duct 104 of the desorption unit 420 via heat exchange between the heat exchangers 424 and 426 as discussed below. Independently or in combination with one another, the heat exchangers 412 and 424 are configured to provide cooling of the exhaust gas 94 flowing through the duct 102 of the adsorption unit 414 and/or cooling of the adsorption modules 100, while the heat exchangers 418 and 426 are configured to provide heating in the duct 104 of the desorption unit 420 and/or heating into the adsorption modules 100. In certain embodiments, the heat exchangers 412 and 424 are integrated together as a combined or common heat exchanger, while the heat exchangers 418 and 426 are integrated together as a combined or common heat exchanger. The cooling provided in the duct 102 of the adsorption unit 414 and/or in the adsorption modules 100 (i.e., when disposed in the duct 102) is configured to help with the adsorption of undesirable gases from the exhaust gas 94 by regulating a temperature within a suitable temperature range for the adsorption process. Similarly, the heating provided in the duct 104 of the desorption unit 420 and/or in the adsorption modules 100 is configured to help with the desorption of undesirable gases from the adsorption modules 100 (i.e., when disposed in the duct 104) by regulating a temperature within a suitable temperature range for the desorption process.

The cooling supply system 410 is coupled to one or more cooling circuits 428 disposed within a housing or body 430 of the heat exchanger 412 within the duct 102 of the adsorption unit 414. The cooling circuit 428 may include fluid flow passages (e.g., sequence of chambers, channels, or other hollow spaces) defining one or more flow paths throughout the housing or body 430, one or more conduits or tubes extending along a flow path throughout the housing or body 430, or a combination thereof. The cooling circuit 428 may include a winding flow path, a coiled flow path, a spiral or helical flow path, a serpentine flow path, a tortuous flow path, or any combination thereof. The cooling circuit 428 is coupled to a manifold 432 of the heat exchanger 412 at an inlet 434 and an outlet 436. In certain embodiments, the housing or body 430 may include a U-shaped structure 438 having a module receptacle or chamber 440 surrounded by opposite sides 442 and 444 (e.g., upstream and downstream sides) and a side 446 (e.g., lateral side) adjacent the manifold 432. The chamber 440 is configured to receive the adsorption module 100 when disposed in the adsorption unit 414. Accordingly, the U-shaped structure 438 has the cooling circuit 428 extending along the sides 442, 444, and 446, thereby providing cooling along at least three sides of the chamber 440 and the adsorption module 100.

The cooling system 166 is configured to circulate a cooling fluid 448 from the coolant supply system 410 into the inlet 434 of the manifold 432, through the cooling circuit 428, and out through the outlet 436 of the manifold 432 back to the cooling supply system 410. In certain embodiments, the cooling supply system 410 receives the cooling fluid 448 already in a cooled state within a suitable temperature range, such that additional temperature adjustments are not performed by any coolers or heat exchangers in the cooling supply system 410. For example, the cooling supply system 410 may receive the cooling fluid 448 from another cooled fluid source in the gas turbine system 10, such as a cooled water from a cooling tower. However, in certain embodiments, the cooling supply system 410 receives the cooling fluid 448 at a temperature outside of a desired temperature range, and thus the cooling supply system 410 may perform additional temperature control (e.g., cooling and/or heating) on the cooling fluid 448 to adjust the temperature within the suitable temperature range. For example, the cooling fluid 448 may be cooled by one or more additional coolers or heat exchangers of the cooling supply system 410, or the cooling fluid 448 may be heated by one or more additional heaters or heat exchangers of the cooling supply system 410.

Accordingly, the cooling supply system 410 may include a single heat exchange or single fluid system 450 and/or a multi-heat exchange or multi-fluid system 452 configured to supply the cooling fluid 448 at the suitable temperature range for circulation and cooling through the cooling circuit 428. In other words, the cooling fluid 448 may be the only cooling fluid (e.g., liquid coolant such as water) used by the single fluid system 450, whereas the cooling fluid 448 (e.g., liquid coolant such as water) may be cooled by another cooling fluid (e.g., liquid or gas) in the multi-fluid system 452. In certain embodiments, the cooling supply system 410 includes one or more pumps, valves, pressure regulators, sensors, filters (e.g., particulate filters, separators, etc.), treatment units (e.g., chemical treatment units, ultraviolet treatment units, etc.), or any combination thereof, configured to control various parameters and quality of the cooling fluid 448 supplied to the heat exchanger 412.

The heating supply system 416 is coupled to one or more heating circuit 460 disposed within a housing or body 462 of the heat exchanger 418 within the duct 104 of the desorption unit 420. The heating circuit 460 may include fluid flow passages (e.g., sequence of chambers, channels, or other hollow spaces) defining one or more flow paths throughout the housing or body 462, one or more conduits or tubes extending along a flow path throughout the housing or body 462, or a combination thereof. The heating circuit 460 may include a winding flow path, a coiled flow path, a spiral or helical flow path, a serpentine flow path, a tortuous flow path, or any combination thereof. The heating circuit 460 is coupled to a manifold 464 of the heat exchanger 418 at an inlet 468 and an outlet 470. The housing or body 462 of the heat exchanger 418 may have a similar construction as the housing or body 430 of the heat exchanger 412. In certain embodiments, the housing or body 462 may include a U-shaped structure 472 having a module receptacle or chamber 480 surrounded by opposite sides 474 and 476 (e.g., upstream and downstream sides) and a side 478 (e.g., lateral side) adjacent the manifold 464. The chamber 480 is configured to receive the adsorption module 100 when disposed in the desorption unit 420. Accordingly, the U-shaped structure 472 has the heating circuit 460 extending along the sides 474, 476, and 478, thereby providing heating along at least three sides of the chamber 480 and the adsorption module 100.

The adsorption module 100 is configured to move in alternating directions (e.g., back and forth) between the chamber 440 in the housing or body 420 within the duct 102 of the adsorption unit 414 and the chamber 480 in the housing or body 462 within the duct 104 of the desorption unit 420. The movement of the adsorption module 100 is described in detail above with reference to FIG. 2, wherein the adsorption module 100 may move back and forth between the chamber 440 in the adsorption unit 414 and the chamber 480 in the desorption unit 420 via the linear positioning assembly 132 of the movable adsorption assembly 108. In certain embodiments, the controller 76 may be configured to selectively engage or disengage the heating and cooling systems 166 and 168 depending on the position of the adsorption module 100, particularly for heating and cooling systems 166 and 168 assigned or coupled to each individual movable adsorption assembly 108 as shown in FIG. 2. If the adsorption module 100 is disposed in the adsorption unit 414, then the controller 76 may deactivate the heating system 168 and activate and/or control the cooling system 166 to provide a suitable temperature range for the adsorption process. If the adsorption module 100 is disposed in the desorption unit 420, then the controller 76 may deactivate the cooling system 166 and activate and/or control the heating system 168 to provide a suitable temperature range for the desorption process.

The heating system 168 is configured to circulate a heating fluid 482 from the heating supply system 416 into the inlet 468 of the manifold 464, through the heating circuit 460, and out through the outlet 470 of the manifold 464 back to the heating supply system 416. In certain embodiments, the heating supply system 416 receives the heating fluid 482 already in a heated state within a suitable temperature range, such that additional temperature adjustments are not performed by any heaters or heat exchangers in the heating supply system 416. For example, the heating supply system 416 may receive the heating fluid 482 from another heated fluid source in the gas turbine system 10, such as a heated water and/or steam 96 from the HRSG 27, the steam turbine 29, and/or the boiler 95. However, in certain embodiments, the heating supply system 416 receives the heating fluid 482 at a temperature outside of a desired temperature range, and thus the heating supply system 416 may perform additional temperature control (e.g., heating and/or cooling) on the heating fluid 482 to adjust the temperature within the suitable temperature range. For example, the heating fluid 482 may be heated by one or more additional heaters or heat exchangers of the heating supply system 416, or the heating fluid 482 may be cooled by one or more additional coolers or heat exchangers of the heating supply system 416.

Accordingly, the heating supply system 416 may include a single heat exchange or single fluid system 484 and/or a multi-heat exchange or multi-fluid system 486 configured to supply the heating fluid 482 at the suitable temperature range for circulation and heating through the heating circuit 460. In other words, the heating fluid 482 may be the only heating fluid (e.g., liquid or gas) used by the single fluid system 484, whereas the heating fluid 482 (e.g., liquid or gas) may be heated by another heating fluid (e.g., liquid or gas) in the multi-fluid system 486. In certain embodiments, the heating supply system 416 may use a heated water, steam, or another heated fluid for circulation directly through the heating circuit 460 as the heating fluid 482, or indirectly as another heating fluid in another heat exchanger to provide heating of the heating fluid 482, or a combination thereof. In certain embodiments, the heating supply system 416 includes one or more pumps, valves, pressure regulators, sensors, filters (e.g., particulate filters, separators, etc.), treatment units (e.g., chemical treatment units, ultraviolet treatment units, etc.), or any combination thereof, configured to control various parameters and quality of the heating fluid 482 supplied to the heat exchanger 418.

The heat exchange system 422 also may be used to provide both cooling in the adsorption unit 414 via the heat exchanger 424 and heating in the desorption unit 420 via the heat exchanger 426. In the illustrated embodiment, the heat exchange system 422 has the heat exchangers 424 and 426 disposed along a closed-loop heat transfer circuit 490, which may be disposed in a housing or body 492 of the heat exchange system 422. The housing or body 492 may include housing portions 494 and 496 disposed in the respective ducts 102 and 104 of the adsorption and desorption units 414 and 420. The housing portions 494 and 496 may be integral portions or separate sections of the housing or body 492. However, the portions 494 and 496 of the housing or body 492 generally support at least part or all of the closed-loop heat transfer circuit 490, including the heat exchangers 424 and 426, a compressor 498, and an expansion valve 500. In some embodiments, the compressor 498 and/or the expansion valve 500 may be disposed in the duct 102, in the duct 104, or externally from both of the ducts 102 and 104.

The closed-loop heat transfer circuit 490 is configured to circulate a working fluid 502 through the heat exchanger 424, the compressor 498, the heat exchanger 426, the expansion valve 500, and back to the heat exchanger 424. The working fluid 502 generally transfers heat, changes phases (e.g., liquid and vapor), and/or becomes heated or cooled while flowing through the closed-loop heat transfer circuit 490. In the illustrated embodiment, the heat exchanger 424 may be an evaporator 504, while the heat exchanger 426 may be a condenser 506. In operation, the exhaust gas 94 flows through the duct 102 of the adsorption unit 414, and transfers heat to the working fluid 502 circulating through the evaporator 504 of the heat exchanger 424, thereby evaporating the working fluid 502 to generate a warm gas or vapor as indicated by arrow 508. Thus, the transfer of heat from the exhaust gas 94 to the working fluid 502 helps to cool the exhaust gas 94 while the adsorption module 100 adsorbs the undesirable gases from the exhaust gas 94. The warm gas 508 then flows through the compressor 498, which compresses the warm gas 508 to generate a hot gas as indicated by arrow 510. The hot gas 510 then flows through the condenser 506 of the heat exchanger 426, thereby transferring heat from the hot gas 510 to the adsorption module 100 (e.g., acting as a heat source for the desorption process) when disposed within the chamber 480. As the heat transfers to the adsorption module 100, the heat helps to desorb the undesirable gases from the sorbent material within the adsorption module 100 as discussed above. Additionally, as the heat transfers to the adsorption module 100, the hot gas 510 cools and condenses in the condenser 506 of the heat exchanger 426, thereby producing a warm liquid as indicated by arrow 512. The warm liquid 512 then passes through the expansion valve 500, which causes an expansion of the warm liquid 512 to provide cooling and generate a cool liquid as indicated by arrow 514. The cool liquid 514 flows through evaporator 504 of the heat exchanger 424, thereby providing cooling to the exhaust gas 94 in the duct 102 of the adsorption unit 414. Again, the cool liquid 514 helps to cool the exhaust gas 94 to a suitable temperature to facilitate the adsorption of undesirable gases in the adsorption module 100, while also becoming heated to generate the warm gas 508 to continue the cycle in the closed-loop heat transfer circuit 490 of the heat exchange system 422.

The working fluid 502 circulating throughout the closed-loop heat transfer circuit 490 may include any suitable thermal fluid, which may undergo a phase change between a liquid and a gas or vapor. For example, the working fluid 502 may include a refrigerant, water, or any other suitable thermal fluid. In the illustrated embodiment, the evaporator 504 of the heat exchanger 424 is coupled to and extends around the U-shaped structure 438 of the housing or body 430 along both the opposite sides 442 and 444, such that the evaporator 504 may provide cooling across the chamber 440 and the adsorption module 100 when disposed in the adsorption unit 414. Similarly, the condenser 506 of the heat exchanger 426 extends across the opposite sides 474 and 476 of the U-shaped structure 472 of the housing or body 462, thereby providing heating across the chamber 480 and the adsorption module 100 when disposed in the desorption unit 420. However, any suitable arrangement of the heat exchangers 424 and 426 may be used with the movable adsorption assembly 108 of the adsorption system 106.

As further illustrated, the adsorption unit 94 outputs the treated gas 97 after adsorption of the undesirable gases (e.g., CO₂) in the adsorption module 100 of the movable adsorption assembly 108. The cooling system 166 is configured to provide cooling to provide a suitable temperature for the exhaust gas 94 and/or sorbent material in the adsorption module 100 to improve the adsorption process in the adsorption module 100 within the adsorption unit 414. Accordingly, the cooling system 166 is configured to provide cooling into the chamber 440 and the adsorption module 100, when disposed in the adsorption unit 414, thereby helping to adsorb the undesirable gases (e.g., CO₂) from the exhaust gas 94 into the sorbent material of the adsorption module 100. In certain embodiments, the cooling system 166 may include the heat exchanger 412 coupled to the cooling supply system 410, the heat exchanger 424 of the heat exchanger system 422, or a combination thereof.

Similarly, the heating system 168 is configured to provide heating to provide a suitable temperature for the sorbent material in the adsorption module 100 to improve the desorption process in the adsorption module 100 within the desorption unit 420. Accordingly, the heating system 168 is configured to provide heat into the chamber 480 and the adsorption module 100, when disposed in the desorption unit 420, thereby helping to desorb the undesirable gases (e.g., CO₂) from the sorbent material of the adsorption module 100 and output a captured gas 520 (e.g., CO₂). In certain embodiments, the heating system 168 may include the heat exchanger 418 coupled to the heating supply system 416, the heat exchanger 426 of the heat exchanger system 422, or a combination thereof.

The captured gas 520 may then flow through downstream equipment 522, which may include a plurality of downstream components 524. The downstream components 524 are configured to facilitate the extraction of the captured gas 520 from the desorption unit 420 and/or further process the captured gas 520. For example, the downstream components 524 may include a vacuum system 526, a dehydration system 528, and compression system 530, and a storage and/or pipeline 532. The vacuum system 526 (e.g., vacuum pump driven by an electric motor) is configured to provide a suction or vacuum to withdraw the captured gas 520 from the duct 104 of the desorption unit 420, when the adsorption module 100 is disposed in the chamber 480 for a desorption process. The dehydration system 528 is configured to extract any moisture, such as water content, from the captured gas 520. The compression system 530 is configured to compress the captured gas 520 for further storage or transport via the storage and/or pipeline 532.

The controller 76 of the control system 14 is coupled to the sensors 86, the cooling system 166, the heating system 168, and the heat exchange system 422 of the thermal control system 101. In particular, the controller 76 may be coupled to the cooling supply system 410, the heating supply system 416, and various components of the heat exchange system 422, such as the compressor 498, the expansion valve 500, or other flow control and monitoring equipment. The sensors 86 may be disposed both upstream and downstream of the movable adsorption assembly 108 in both the duct 102 of the adsorption unit 414 and the duct 104 of the desorption unit 420. Accordingly, the sensors 86 may provide sensor feedback both upstream and downstream of the movable adsorption assembly 108, such as sensor feedback of temperature, gas composition, pressure, flow rate, or any combination thereof, which may facilitate controls of the temperature in the adsorption unit 414 and the desorption unit 420 via the thermal control system 101. For example, if the sensors 86 indicate a temperature that is either too high or too low in the adsorption unit 414 or the desorption unit 420, then the controller 76 may be configured to control the temperatures via the cooling supply system 410 of the cooling system 166, the heating supply system 416 of the heating system 168, and the compressor 498 and/or the expansion valve 500 of the heat exchange system 422.

In certain embodiments, the adsorption system 106 of the gas treatment system 16 may include all or part of the thermal control system 101 for temperature control in the adsorption unit 414 and the desorption unit 420. For example, the thermal control system 101 may include only the heat exchange system 422, only the cooling system 166 having the heat exchanger 412, only the heating system 168 having the heat exchanger 418, or all aspects of the thermal control system 101, including the cooling system 166, the heating system 168, and the heat exchange system 422. Additionally, the cooling supply system 410 and the heating supply system 416 may have various embodiments, such as the single fluid systems 450 and 484 and/or the multi-fluid systems 452 and 486 as discussed in further detail below.

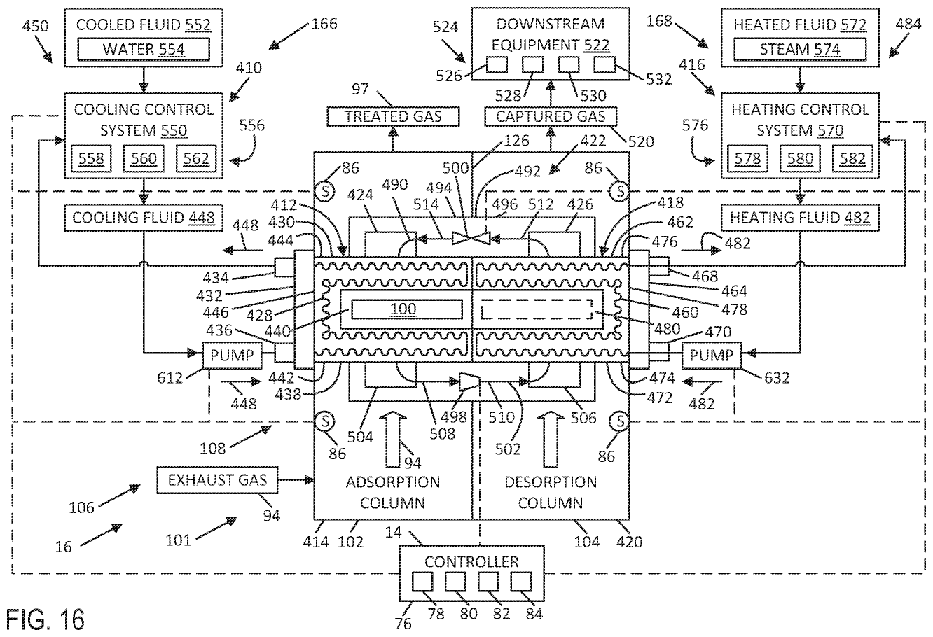

FIG. 16 is a schematic of an embodiment of the gas treatment system 16 of FIGS. 1-15, further illustrating details of the single fluid systems 450 and 484 of the cooling supply system 410 and the heating supply system 416 of the thermal control system 101 of FIG. 15. In certain embodiments, the single fluid systems 450 and 484 are configured to obtain thermal fluids (e.g., cooled fluid 552 and heated fluid 572) from other source equipment in the gas turbine system 10, wherein the thermal fluids may already be at suitable temperatures for cooling and heating in the thermal control system 101. For example, the thermal control system 101 may include the heat exchangers 412 and 418 disposed inside the respective adsorption and desorption units 414 and 420, wherein the thermal fluids (e.g., cooled fluid 552 and heated fluid 572) may be routed from their respective source equipment to the heat exchangers 412 and 418. The source equipment may include the HRSG 27, the steam turbine 29, the boiler 95, a water cooling tower, a water reservoir, or any combination thereof. In some embodiments, additional heat exchangers may be used to adjust the temperature of the thermal fluids; however, the thermal fluids may still be received from other source equipment and routed through the heat exchangers 412 and 418.

In the illustrated embodiment, the single fluid system 450 of the cooling supply system 410 includes a cooling control system 550 configured to receive a cooled fluid 552, such as water 554. The cooling control system 550 is configured to supply the cooled fluid 552 as the cooling fluid 448 through the cooling circuit 428 of the heat exchanger 412 disposed in the duct 102 of the adsorption unit 414. The cooling control system 550 may include a plurality of cooling control components 556, such as cooling control components 558, 560, and 562. The cooling control component 558 may include one or more flow control components, such as one or more valves, pumps, pressure regulators, or any combination thereof, which may be controlled by the controller 76, which may be controlled by the controller 76 to control the flow of the cooled fluid 552 as the cooling fluid 448 into and through the cooling circuit 428. The cooling control component 560 may include one or more filters or fluid treatment components, such as particulate filters, ultraviolet light treatment systems, chemical treatment systems, separators, or any combination thereof. The cooling control component 562 may include one or more temperature control components, such as temperature sensors, temperature controls to adjust the flow rate (e.g., via the flow control components 558), temperature controls to adjust the temperature (e.g., coolers and/or heaters), or any combination thereof. For example, the temperature control components may include coolers configured to cool the cooled fluid 552 for use as the cooling fluid 448 by transferring heat away from the cooled fluid 552 via one or more heat exchangers. For example, the coolers may include a fan configured to direct an airflow across the heat exchangers to transfer heat away from the cooled fluid 552, or the coolers may include a pump configured to circulate a different fluid through the heat exchangers to transfer heat away from the cooled fluid 552. By further example, the coolers may include one or more expanders (e.g., turbo-expanders) configured to reduce the temperature of the cooled fluid 552 via an expansion process. In certain embodiments, if the temperature of the cooled fluid 552 is below a lower temperature threshold, then the temperature control components may include heaters configured to heat the cooled fluid 552 for use as the cooling fluid 448 by transferring heat into the cooled fluid 552 via one or more heat exchangers. In some embodiments, the temperature control components may exclude any additional heat exchangers, fans, pumps, and/or expanders, such that the cooled fluid 552 may be received and supplied into the heat exchanger 412 without any further temperature adjustments.

The cooling control system 550 may receive the cooling fluid 552 from one or more sources throughout the system 10. For example, the cooling fluid 552 may be received from the HRSG 27, the steam turbine 29, a water cooling tower, a water reservoir, a water treatment system for the gas turbine system 10, or another independent thermal system of the gas turbine system 10, or any combination thereof. In some embodiments, the cooling fluid 552 may not be directed from another external source in the gas turbine system 10, but rather the cooling control system 550 may operate as a closed-loop by circulating the cooling fluid 448 through the cooling circuit 428 and the cooling control system 550. In either case, the cooling control system 550 operates as the single fluid system 450, using the one cooling fluid 448 for circulation throughout the cooling circuit 428. The cooling system 166 having the single fluid system 450 operates substantially the same as discussed above with reference to FIG. 15, wherein the cooling fluid 448 is provided to help regulate the temperature of the exhaust gas 94 and/or the adsorption modules 100 within a suitable temperature range to improve the adsorption process within the adsorption modules 100.

The heating system 168 has the heating supply system 416 with the single fluid system 484, wherein the single fluid system 484 includes a heating control system 570 configured to receive a heated fluid 572, such as a steam 574. The heating control system 570 is configured to supply the heated fluid 572 as the heating fluid 482 for circulation throughout the heating circuit 460 of the heat exchanger 418 in the desorption unit 420. The heated fluid 572 may include the steam 574, such as the steam 96 from the HRSG 27, the steam turbine 29, the boiler 95, one or more additional steam sources or generators, or any combination thereof. In some embodiments, the heated fluid 572 may alternatively or additionally include a heated water, a heated lubricant, or another heated liquid or gas available in the gas turbine system 10.

The heating control system 570 may include one or more heating control components 576, such as heating control components 578, 580, and 582. The heating control component 578 may include one or more flow control components, such as one or more valves, pumps, pressure regulators, or any combination thereof, which may be controlled by the controller 76 to control the flow of the heated fluid 572 as the heating fluid 482 into and through the heating circuit 460. The heating control component 580 may include one or more filters or fluid treatment components, such as particulate filters, ultraviolet light treatment systems, chemical treatment systems, separators, water removal units or drains, or any combination thereof. The heating control component 582 may include one or more temperature control components, such as temperature sensors, temperature controls to adjust the flow rate (e.g., via the flow control components 580, temperature controls to adjust the temperature (e.g., coolers and/or heaters), or any combination thereof. For example, the temperature control components may include heaters configured to heat the heated fluid 572 for use as the heating fluid 482 by transferring heat into the heated fluid 572 via one or more heat exchangers. For example, the heaters may include one or more electric heaters, or the heaters may include a pump configured to circulate a different fluid through the heat exchangers to transfer heat into the heated fluid 572. In certain embodiments, if the temperature of the heated fluid 572 is above an upper temperature threshold, then the temperature control components may include coolers configured to cool the heated fluid 572 for use as the heating fluid 482 by transferring heat away from the heated fluid 572 via one or more heat exchangers.

In some embodiments, the temperature control components may exclude any additional heat exchangers, heaters, coolers, and/or pumps, such that the heated fluid 572 may be received and supplied into the heat exchanger 418 without further temperature adjustments. For example, the heating control system 570 may selectively extract or receive the heat fluid 572 from one or more sources, depending on the conditions at the sources and the suitable temperature range for the desorption process. In certain embodiments, the heat control system 57 may selectively extract the heat fluid 572 (e.g., steam 574) from one or more of a low-pressure (LP) section, an intermediate-pressure (IP) section, and/or a high-pressure (HP) section of the HRSG 27 and/or the steam turbine 29. Accordingly, the steam 574 may be a low-pressure (LP) steam, an intermediate-pressure (IP) steam, or a high-pressure (HP) steam, depending on the extraction points from the HRSG 27 and/or the steam turbine 29. The steam 574 also may be extracted from other sources, such as the boiler 95 and/or steam generators in the gas turbine system 10. Additionally, the heat fluid 572 may be a mixture of the steam 574 and a heated water. By controlling the extraction points, the heating control system 570 may be configured to supply the heated fluid 572 without further heating, or in some conditions, with some cooling to reduce the temperature.

Accordingly, the heating control system 570 regulates, processes, and controls the temperature of the heated fluid 572, such as the steam 574, which may be used directly as the heating fluid 482 for heating the sorbent materials in the adsorption module 100 within the chamber 480 via heat exchange along the heating circuit 460. Again, the addition or heat transfer of heat into the adsorption module 100 helps to desorb the undesirable gases from the adsorption module 100, thereby producing the captured gas 520. The heating fluid 482, such as the steam 574, flows through the heating circuit 460, thereby transferring heat to the sorbent materials in the adsorption module 100 and facilitating desorption of the undesirable gases to produce the captured gas 520.

In the illustrated embodiment, the controller 76 of the control system 14 is coupled to both the cooling control system 550 and a heating control system 570, thereby monitoring and controlling the temperature and supply of the cooling fluid 448 through the cooling circuit 428 and the heating fluid 482 through the heating circuit 460. Again, as discussed above with reference to FIG. 15, the controller 76 may monitor the sensors 86 upstream and downstream of the adsorption module 100 (e.g., when disposed in the adsorption unit 414 and the desorption unit 420), thereby helping to control the adsorption and desorption processes via control of the temperatures in each of the adsorption and desorption units 4414 and 420. The controller 76 is also coupled to the heat exchange system 422 for control of the cooling by the heat exchanger 424 and the heating by the heat exchanger 426 as discussed in detail above with reference to FIG. 15. Other than noted above, the adsorption system 106 of the gas treatment system 16 of FIG. 16 is substantially the same as discussed above with reference to FIG. 15.

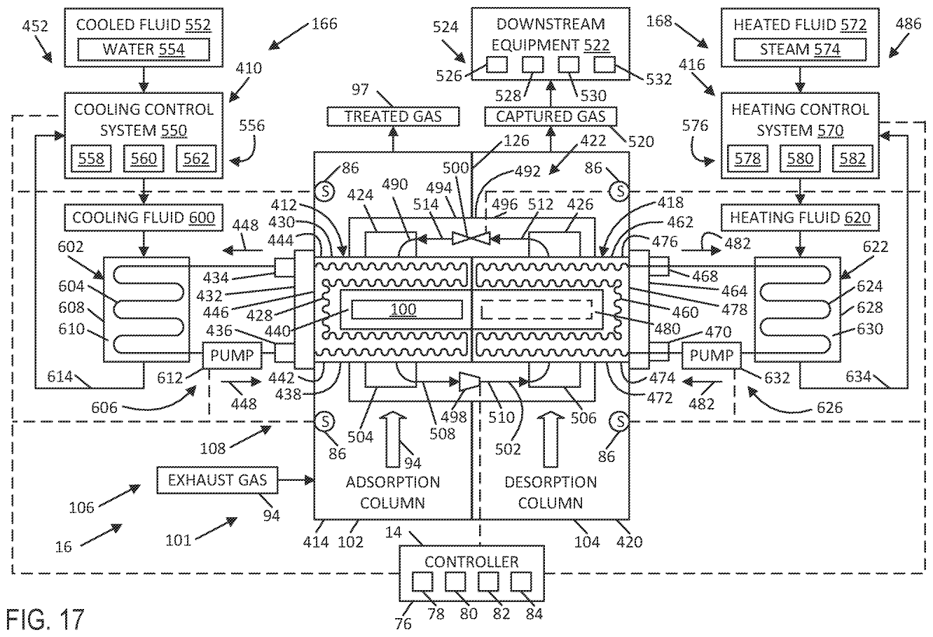

FIG. 17 is a schematic of an embodiment of the gas treatment system 16 of FIGS. 1-15, further illustrating aspects of the multi-fluid systems 452 and 486 of the cooling supply system 410 and the heating supply system 416 of the thermal control system 101. Otherwise, the components and functionality described above with reference to FIG. 15 are substantially the same in FIG. 17. In certain embodiments, the multi-fluid systems 452 and 486 are configured to obtain thermal fluids (e.g., cooled fluid 552 and heated fluid 572) from other source equipment in the gas turbine system 10, wherein the thermal fluids may not be within suitable temperature ranges to enable or improve adsorption of the undesirable gases in the adsorption unit 414 and/or desorption of the undesirable gases in the desorption unit 420. Accordingly, the multi-fluid systems 452 and 486 provide indirect heat transfer between the thermal fluids (e.g., cooled fluid 552 and heated fluid 572) and the cooling and heating fluids 448 and 482 via one or more additional heat exchangers (e.g., heat exchangers 602 and 622). As a result, the multi-fluid system 452 is configured to provide a heat exchange between at least two fluids to control a temperature within a suitable cooling temperature range to enable or improve the adsorption process, whereas the multi-fluid system 486 is configured to provide a heat exchange between at least two fluids to control a temperature within a suitable heating temperature range to enable or improve the desorption process.

In the illustrated embodiment, the multi-fluid system 452 of the cooling supply system 410 includes the cooling control system 550 having the cooling control components 556 as discussed above. The cooling control system 550 is configured to receive the cooling fluid 552, such as water 554, and regulate and deliver the cooling fluid 552 as a cooling fluid 600 to the heat exchanger 602. The heat exchanger 602 is configured to transfer heat (e.g., indirect heat transfer) between the cooling fluid 448 and the cooling fluid 600, wherein the cooling fluids 448 and 600 are separate from one another. The cooling fluid 448 circulates through the cooling circuit 428 of the heat exchanger 412 and a cooling circuit 604 of the heat exchanger 602, wherein the cooling circuits 428 and 604 collectively define a single closed-loop cooling circuit 606 extending through both heat exchangers 412 and 602. In certain embodiments, the cooling circuit 604 of the heat exchanger 602 is removably or fixedly coupled to the cooling circuit 428 of the heat exchanger 412, wherein the heat exchanger 602 is disposed outside of the adsorption unit 414 and the heat exchanger 414 is disposed inside the adsorption unit 414.

The heat exchanger 602 has a body or housing 608 with a cooling flow path 610 disposed along and around the cooling circuit 604. For example, the cooling flow path 610 may include one or more flow paths, channels, or cavities within the body or housing 608, wherein the cooling flow path 610 substantially surrounds the cooling circuit 604 within the body or housing 608. The cooling circuit 604 may include a cooling coil, winding tubing, or any combination thereof, separate from the cooling flow path 610. In certain embodiments, the cooling circuit 604 may include one or more conduits or tubing extending in a winding flow path, a coiled flow path, a spiral or helical flow path, a serpentine flow path, a tortuous flow path, or any combination thereof.

In operation, the cooling fluid 600 from the cooling supply system 410 flows through the cooling flow path 610 of the heat exchanger 602, wherein the cooling fluid 600 is configured to adjust (e.g., decrease or increase) a temperature of the cooling fluid 448 circulating through the cooling circuit 606. For example, the cooling fluid 600 may transfer heat away from the cooling fluid 448 in the heat exchanger 602, thereby cooling the cooling fluid 448 to a temperature within a suitable temperature range for the adsorption process. In some embodiments, the cooling fluid 600 may transfer heat into the cooling fluid 448 in the heat exchanger 602, thereby heating the cooling fluid 448 to a temperature within a suitable temperature range for the adsorption process. Thus, the heat exchanger 602 generally transfers heat between the cooling fluids 448 and 600, such that the cooling fluid 448 is thermally adjusted to a temperature within a suitable temperature range for the adsorption process. The direction of heat transfer may depend on the source and temperature of the cooled fluid 552, the temperature of the exhaust gas 94, and other considerations.

After transferring heat between the cooling fluids 448 and 600, the heat exchanger 602 discharges the thermally adjusted cooling fluids 448 and 600. The cooling fluid 448 discharged from the heat exchanger 602 flows through the heat exchanger 412 to cool the exhaust gas 94 to enable or improve the adsorption process. The cooling fluid 448 may then flow back to the heat exchanger 602 to complete the closed-loop cooling circuit 606, wherein the cooling fluid 448 then starts another pass through the closed-loop cooling circuit 606. In the illustrated embodiment, the closed-loop cooling circuit 606 includes one or more pumps 612 configured to pump the cooling fluid 448 through the closed-loop cooling circuit 606, including the cooling circuits 428 and 604 of the heat exchangers 412 and 602. Separately, after the cooling fluid 600 flows through and exits the heat exchanger 602, the cooling fluid 600 may flow or recirculate to the cooling control system 550 and/or flow to another location in the gas turbine system 10 along one or more flow paths. In some embodiments, the cooling fluid 600 may flow through a closed-loop cooling circuit 614 having the cooling control system 550 and the heat exchanger 602.

Thus, the multi-fluid system 452 includes at least the cooling fluid 448 circulating through the cooling circuit 606 (e.g., through the heat exchangers 412 and 602), and the cooling fluid 600 circulating through the cooling circuit 614 (e.g., through the heat exchanger 602 and the cooling control system 550). The cooling control system 550 operates substantially the same as discussed above with reference to FIG. 16. However, the cooling control system 550 receives the cooled fluid 552 and outputs the cooling fluid 600 for use in cooling the cooling fluid 448 via indirect heat exchange in the heat exchanger 602. Otherwise, the cooling supply system 410, including the multi-fluid system 452, operates substantially the same as discussed above with reference to FIGS. 15 and 16.

In the illustrated embodiment, the multi-fluid system 486 of the heating supply system 416 includes the heating control system 570 having the heating control components 576 as discussed above. The heating control system 570 is configured to receive the heated fluid 572, such as the steam 574, and regulate and deliver the heated fluid 572 as a heating fluid 620 to the heat exchanger 622. The heat exchanger 622 is configured to transfer heat (e.g., indirect heat transfer) between the heating fluid 482 and the heating fluid 620, wherein the heating fluids 482 and 620 are separate from one another. The heating fluid 482 circulates through the heating circuit 460 of the heat exchanger 418 and a heating circuit 624 of the heat exchanger 622, wherein the heating circuits 460 and 624 collectively define a single closed-loop heating circuit 626 extending through both heat exchangers 418 and 622. In certain embodiments, the heating circuit 624 of the heat exchanger 622 is removably or fixedly coupled to the heating circuit 460 of the heat exchanger 416, wherein the heat exchanger 622 is disposed outside of the desorption unit 420 and the heat exchanger 418 is disposed inside the desorption unit 420.

The heat exchanger 622 has a body or housing 628 with a heating flow path 630 disposed along and around the heating circuit 624. For example, the heating flow path 630 may include one or more flow paths, channels, or cavities within the body or housing 628, wherein the heating flow path 630 substantially surrounds the heating circuit 624 within the body or housing 628. The heating circuit 624 may include one or more coils, winding tubes, or any combination thereof, separate from the heating flow path 630. In certain embodiments, the heating circuit 624 may include one or more conduits or tubing extending in a winding flow path, a coiled flow path, a spiral or helical flow path, a serpentine flow path, a tortuous flow path, or any combination thereof.

In operation, the heating fluid 620 from the heating supply system 416 flows through the heating flow path 630 of the heat exchanger 622, wherein the heating fluid 620 is configured to adjust (e.g., increase or decrease) a temperature of the heating fluid 482 circulating through the heating circuit 626. For example, the heating fluid 620 may transfer heat into the heating fluid 482 in the heat exchanger 622, thereby heating the heating fluid 482 to a temperature within a suitable temperature range for the desorption process. In some embodiments, the heating fluid 620 may transfer heat away from the heating fluid 482 in the heat exchanger 622, thereby cooling the heating fluid 482 to a temperature within a suitable temperature range for the desorption process. Thus, the heat exchanger 622 generally transfers heat between the heating fluids 482 and 620, such that the heating fluid 482 is thermally adjusted to a temperature within a suitable temperature range for the desorption process. The direction of heat transfer may depend on the source and temperature of the heated fluid 572, the temperature of the sorbent materials in the adsorption modules 200, and other considerations.

After transferring heat between the heating fluids 482 and 620, the heat exchanger 622 discharges the thermally adjusted heating fluids 482 and 620. The heating fluid 482 discharged from the heat exchanger 622 flows through the heat exchanger 418 to heat the sorbent materials in the adsorption modules 100 to enable or improve the desorption process. The heating fluid 482 may then flow back to the heat exchanger 622 to complete the closed-loop heating circuit 626, wherein the heating fluid 482 then starts another pass through the closed-loop heating circuit 626. In the illustrated embodiment, the closed-loop heating circuit 626 includes one or more pumps 632 configured to pump the heating fluid 482 through the closed-loop heating circuit 626, including the heating circuits 460 and 624 of the heat exchangers 418 and 622. Separately, after the heating fluid 620 flows through and exits the heat exchanger 622, the heating fluid 620 may flow or recirculate to the heating control system 570 and/or flow to another location in the gas turbine system 10 along one or more flow paths. In some embodiments, the heating fluid 620 may flow through a closed-loop heating circuit 634 having the heating control system 570 and the heat exchanger 622.

Thus, the multi-fluid system 486 includes at least the heating fluid 482 circulating through the heating circuit 626 (e.g., through the heat exchangers 418 and 622), and the heating fluid 620 circulating through the heating circuit 634 (e.g., through the heat exchanger 622 and the heating control system 570). The heating control system 570 operates substantially the same as discussed above with reference to FIG. 16. However, the heating control system 570 receives the heated fluid 572 and outputs the heating fluid 620 for use in heating the heating fluid 482 via indirect heat exchange in the heat exchanger 622. Otherwise, the heating supply system 416, including the multi-fluid system 486, operates substantially the same as discussed above with reference to FIGS. 15 and 16.

The thermal fluids or heat transfer fluids used for the cooling fluids 448 and 600 and the heating fluids 482 and 620 may include any suitable liquids and/or gases, wherein the fluids may be the same or different from one another. For example, the cooling fluids 448 and 600 may include water, lubricants, oil, air, inert gases (e.g., nitrogen), or any combination thereof. The cooling fluid 448 may be contained in the closed-loop cooling circuit 606, whereas the cooling fluid 600 may or may not be disposed in the closed-loop cooling circuit 614. By further example, the heating fluids 482 and 620 may include steam, a heated water, a heated gas, a heated liquid, or any combination thereof. For example, the heating fluid 620 may include the steam 574, which may include the steam 96 from HRSG 27, the steam turbine 29, or the boiler 95. Additionally, the steam 96 may include a low-pressure (LP) steam, an intermediate-pressure (IP) steam, or a high-pressure (HP) steam, depending on the extraction points from one or more of a low-pressure (LP) section, an intermediate-pressure (IP) section, and/or a high-pressure (HP) section of the HRSG 27 and/or the steam turbine 29. The heating fluid 482 may include a gas or liquid, such as water, an oil, a lubricant, or a combination thereof.

In operation, the controller 76 is coupled to the sensors 86 and the multi-fluid systems 452 and 486 of the cooling and heating supply systems 410 and 416, thereby helping to provide thermal control in the adsorption unit 414 and the desorption unit 420 of the adsorption system 106. For example, the controller 76 may monitor conditions upstream and downstream of the adsorption modules 100 in the adsorption and desorption units 414 and 420, and then adjust the pumps 612 and 632, the components 556 of the cooling control system 550, the components 576 of the heating control system 570, or any combination thereof, to provide suitable temperatures for the thermal fluids (e.g., 448, 600, 482, and 620). As the adsorption unit 414 adsorbs the undesirable gases from the exhaust gas 94 via the adsorption module 100, which has the temperature control by the cooling system 166 and the heat exchange system 422, the adsorption unit 414 produces the treated gas 97. Additionally, the desorption unit 420 removes the undesirable gases from the adsorption module 100, wherein the heating system 168 and the heat exchange system 422 provide heat to enable or improve the desorption process to produce the captured gas 520. The downstream equipment 522 then further processes the captured gas 520.

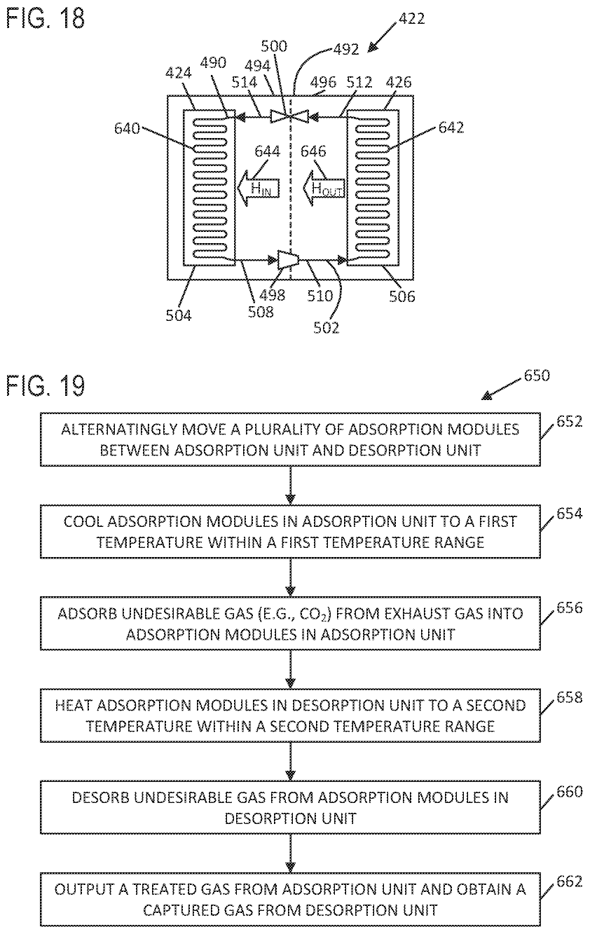

FIG. 18 is a schematic of an embodiment of the gas treatment system 16 of FIGS. 1-17, further illustrating aspects of the heat exchange system 422 of FIGS. 15-17. The heat exchange system 422 includes the closed-loop heat transfer circuit 490 having the heat exchanger 424 (e.g., evaporator 504), the compressor 498, the heat exchanger 426 (e.g., condenser 506), and the expansion valve 500 as discussed in detail above. The heat exchange system 422 also includes the housing or body 492 having the housing portion 494 configured to mount in the adsorption unit 414 and the housing portion 496 configured to mount in the desorption unit 420. As further illustrated in FIG. 18, the heat exchanger 424 include a heat exchange tubing 640 and the heat exchanger 426 includes a heat exchange tubing 642, wherein the heat exchange tubing 640 and 642 may extend along a winding flow path, a coiled flow path, a spiral or helical flow path, a serpentine flow path, a tortuous flow path, or any combination thereof. In the adsorption unit 414, the heat exchanger 424 is configured to receive heat (or transfer heat in) from the exhaust gas 94 into the working fluid 502 in the heat exchange tubing 640 as indicated by arrow 644, thereby providing cooling of the exhaust gas 94 and the adsorption modules 100 in the adsorption unit 414. The cooling helps to enable or improve the adsorption process of undesirable gases into the adsorption modules 100 in the adsorption unit 414. In the desorption unit 420, the heat exchanger 426 is configured to output heat (or transfer heat out) from the working fluid 502 in the heat exchange tubing 642 as indicated by arrow 646, thereby providing heating of the adsorption modules 100 in the desorption unit 420. The heating helps to enable or improve the desorption process of undesirable gases from the adsorption modules 100 in the desorption unit 420.

In certain embodiments, the heat exchange system 422 may have the heat exchangers 424 and 426, the compressor 498, and the expansion valve 500 of the closed-loop heat transfer circuit 490 arranged or configured as a heat pump cycle or refrigeration cycle, such as a vapor-compression cycle or a vapor absorption cycle. Thus, the working fluid 502 may include a refrigerant, such as R-32, HFC-32, or difluoromethane (CH₂F₂); R-134a, HFC-134a, or 1,1,1,2-tetrafluoroethane (CF₃CH₂F); R-410a or pentafluoroethane (CF₃CHF₂); R-290 or propane (C₃H₈); R-600a or isobutane (HC(CH₃)₃); R-717 or ammonia (NH₃); R-744 or carbon dioxide (CO₂); R-1234yf, HFO-1234yf, or 2,3,3,3-Tetrafluoropropene (C₃H₂F₄); or any combination thereof. However, the working fluid 502 may include any suitable refrigerant or thermal fluid.

The heat exchange system 422 may be configured and/or mounted in a variety of ways within the adsorption and desorption units 414 and 420. In some embodiments, the heat exchangers 424 and 426 may be directly coupled to and/or integrated with the moveable adsorption assemblies 108. However, in some embodiments, the heat exchangers 424 and 426 may be independently and/or separately mounted relative to the moveable adsorption assemblies 108 in the adsorption and desorption units 414 and 420. For example, the heat exchangers 424 and 426 may be mounted directly at the same positions of the moveable adsorption assemblies 108, between successive positions of the moveable adsorption assemblies 108, upstream from all of the moveable adsorption assemblies 108, or any combination thereof.

FIG. 19 is a flow chart of an embodiment of a gas treatment process 650 of the gas treatment system 16 of FIGS. 1-18. As illustrated, the process 650 includes alternatingly moving a plurality of adsorption modules 100 between the adsorption unit 414 and the desorption unit 420 as indicated by block 652. For example, the adsorption modules 100 may move in alternating directions along a path of travel between the duct 102 of the adsorption unit 414 and the duct 104 of the desorption unit 420. The path of travel may be linear using the linear positioning assemblies 132 as described above. In some embodiments, the path of travel may be a non-linear path of travel, such as a curved path of travel, a multi-angled path of travel, a wavy path of travel, or any combination thereof. The process 650 includes cooling the adsorption modules 100 in the adsorption unit 414 to a first temperature within a first temperature range, as indicated by block 654. The cooling may be provided with the cooling system 166, including the heat exchanger 412 coupled to the cooling supply system 410 and/or the heat exchanger 424 of the heat exchange system 422. The process 650 further includes adsorbing an undesirable gas (e.g., CO₂) from the exhaust gas 94 into the adsorption modules 100 in the adsorption unit 414, as indicated by block 656. The first temperature within the first temperature range may be suitable for enabling and/or improving the adsorption of the undesirable gas within sorbent material of the adsorption modules 100.

The process 650 includes heating the adsorption modules 100 in the desorption unit 420 to a second temperature within a second temperature range, as indicated by block 658. The heating may be provided with the heating system 168, including the heat exchanger 418 coupled to the heating supply system 416 and/or the heat exchanger 426 of the heat exchange system 422. The process 650 further includes desorbing the undesirable gas (e.g., CO₂) from the adsorption modules 100 in the desorption unit 420, as indicated by block 660. The second temperature within the second temperature range may be suitable for enabling and/or improving the desorption of the undesirable gas from the sorbent material of the adsorption modules 100. The process 650 further includes outputting the treated gas 97 from the adsorption unit 414 and obtaining the captured gas 520 from the desorption unit 420.

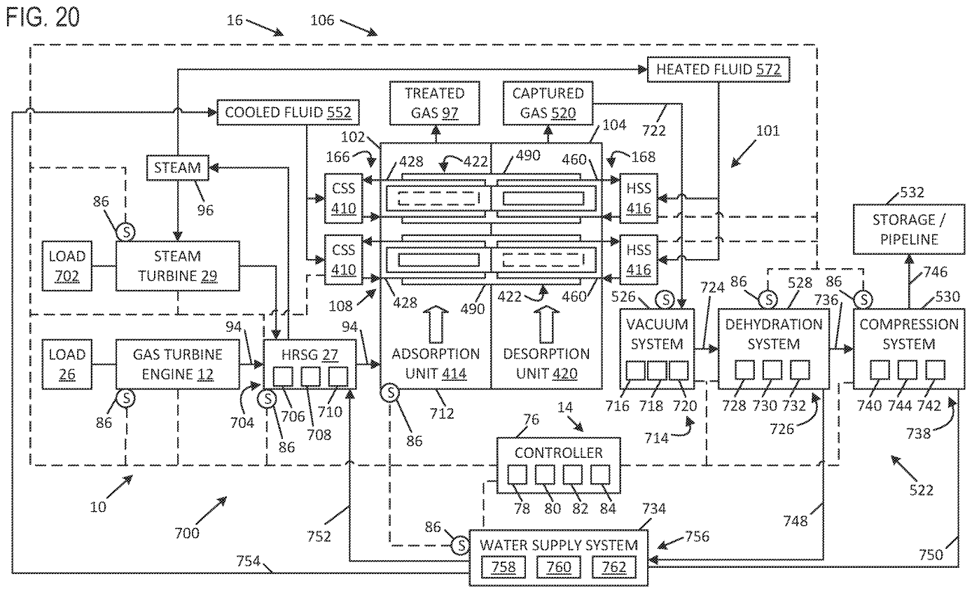

FIG. 20 is a block diagram of an embodiment of a combined cycle power plant 700 having the gas turbine system 10 of FIG. 1, further illustrating details of the adsorption system 106 and the thermal control system 101 of the gas treatment system 16. The combined cycle power plant 700 has the gas turbine engine 12 configured to combust a fuel to generate an exhaust gas 94, which flows through the HRSG 27 to generate the steam 96 for the steam turbine 29. The gas treatment system 16 is configured to receive and use thermal fluids available in the combined cycle power plant 700 for the cooled fluid 552 and the heated fluid 572 for the thermal control system 101 of the adsorption system 106, thereby helping to enable and/or improve the efficiency of the adsorption and desorption processes while improving the overall efficiency of the combined cycle power plant 700. For example, the cooled fluid 552 may include water or other fluids acquired from the combined cycle power plant 700 in one or more conditions (e.g., temperatures, pressures, composition, etc.), wherein the cooled fluid 552 is used by the cooling system 166 to help with the adsorption process in the adsorption modules 100. By further example, the heated fluid 572 may include the steam 96 and/or heated water from the HRSG 27 and/or the steam turbine 29 in one or more conditions (e.g., temperatures, pressures, steam/water content, etc.), wherein the heated fluid 572 is used by the heating system 168 to help with the desorption process in the adsorption modules 100. As noted above, although the adsorption system 106 may be well-suited for the removal and capture of CO₂, the undesirable gases may include any one or more of carbon oxides (COx) such as carbon dioxide (CO₂) and carbon monoxide (CO), nitrogen oxides (NOx) such as nitrogen dioxide (NO₂), sulfur oxides (SOx) such as sulfur dioxide (SO₂), or any combination.

In the illustrated embodiment, the gas turbine engine 12 is drivingly coupled to the load 26, such as an electric generator. Similarly, the steam turbine 29 is drivingly coupled to a load 702, such as an electric generator. Collectively, the gas turbine engine 12 and the steam turbine 29 drive the loads 26 and 702 (e.g., electric generators) to generate electricity for the combined cycle power plant 700 and a power grid. The HRSG 27 may include a plurality of sections 704, such as a low-pressure (LP) section 706, an intermediate-pressure (IP) section 708, and a high-pressure (HP) section 710, which are configured to generate the steam 96 as a low-pressure (LP) steam, an intermediate-pressure (IP) steam, and a high-pressure (HP) steam, respectively. The HRSG 27 transfers heat from the exhaust gas 94 to water and/or steam to generate the LP, IP, and HP steam. In certain embodiments, the steam turbine 29 includes a plurality of steam turbine sections, such as a low-pressure (LP) steam turbine section, an intermediate-pressure (IP) steam turbine section, and a high-pressure (HP) steam turbine section, which are driven by the LP, IP, and HP steam, respectively. Additionally, the adsorption system 106 of the gas treatment system 16 may receive and use the steam 96 as the heated fluid 572, wherein the steam 96 may include one or more of the LP, IP, and HP steam and/or heated water from the HRSG 27 and/or the steam turbine 29. After generating the steam 96, the HRSG 27 passes the exhaust gas 94 to an exhaust stack 712 (e.g., vertical exhaust stack or duct).

In the illustrated embodiment, the adsorption system 106 and the thermal control system 101 may be coupled to the exhaust stack 712, wherein the adsorption system 106 and the thermal control system 101 may be at least partially or substantially disposed within the exhaust stack 712. For example, the exhaust stack 712 may include the duct 102 of the adsorption unit 414, such that the adsorption unit 414 is in-line with the exhaust stack 712. By further example, the duct 104 of the desorption unit 420 may extend along (e.g., parallel with) the exhaust stack 712, such that the desorption unit 420 is adjacent the desorption unit 414 to enable movement of the adsorption modules 100 back and forth between the exhaust stack 712 (e.g., duct 102) and the duct 104 as discussed in detail above. In particular, each movable adsorption assembly 108 has one of the adsorption modules 100 configured to move in alternating directions between the ducts 102 and 104, wherein the adsorption modules 100 adsorb undesirable gases in the duct 102 and desorb the undesirable gases in the deduct 104. The adsorption unit 414 outputs the treated gas 97 downstream from the plurality of moveable adsorption assemblies 108, while the desorption unit 420 outputs the captured gas 520 downstream from the plurality of moveable adsorption assemblies 108. In the illustrated embodiments, the ducts 102 and 104 are generally oriented in a vertical direction associated with the exhaust stack 712, whereas the alternating directions of movement of the adsorption modules 100 are generally in a horizontal direction. The adsorption system 106 routes the captured gas 520 to the downstream equipment 522 as discussed in further detail below.

The thermal control system 101 is configured to provide temperature control for the adsorption and desorption units 414 and 420, wherein the thermal control system 101 includes the cooling system 166 and the heating system 168. The cooling system 166 includes the cooling supply system 410 coupled to the heat exchanger 412, and at least part of the heat exchange system 422 (e.g., the heat exchanger 424). The heating system 168 includes the heating supply system 416 coupled to the heat exchanger 418, and at least part of the heat exchange system 422 (e.g., the heat exchanger 426). In the illustrated embodiment, the adsorption system 106 includes two of the moveable adsorption assemblies 108 coupled to the exhaust stack 712. However, the adsorption system 106 may include any number of the moveable adsorption assemblies 108 (e.g., 1, 2, 3, 4, 5, 6, 7, 8, 9, 10, or more) coupled to the exhaust stack 712.

In the illustrated embodiment, the downstream equipment 522 includes a vacuum system 526, a dehydration system 528, a compression system 530, and a storage and/or pipeline system 532. The vacuum system 526 is configured to create a vacuum to suck the undesirable gases out of the desorption unit 420 and the adsorption modules 100 via one or more vacuum components 714. In certain embodiments, the vacuum components 714 may include a vacuum 716, such as a pump, fan, compressor, or a combination thereof, which may be driven by an electric motor or other drive. The vacuum components 714 also may include a vacuum control 718, such as a vacuum pressure control, a vacuum speed control, a vacuum flow control, or a combination thereof, configured to adjust the vacuum 716 to provide a suitable suction to extract the undesirable gases. The vacuum components 714 also may include one or more filters 720, such as particulate filters. The vacuum system 526 receives the captured gas 520 as indicated by arrow 722, and outputs the captured gas 520 to the dehydration system 528 as indicated by arrow 724.

The dehydration system 528 is configured to dehydrate or generally remove moisture from the captured gas 520 via one or more dehydration components 726. For example, the dehydration components 726 may include a heat exchanger 728, a separator 730, and a water collector 732. The heat exchanger 728 may be configured to cool the captured gas 520, thereby causing condensation of any moisture within the captured gas 520. The separator 730 may include a water gas separator configured to separate the condensed water from the captured gas 520. In certain embodiments, the separator 730 may include a gravity separator, a centrifugal separator, or any other type of separation unit, or any combination thereof. The water collector 732 may be configured to collect the condensed and separated water and return the water back to a water supply system 734 for subsequent use in the combined cycle power plant 700. In some embodiments, the water collector 732 may include a water drain system, a water tank, a water pump, a water filter, or any combination thereof. As appreciated, the dehydration system 528 may include one or more types of dehydration components 726. The dehydration system 528, after performing various dehydration processes, outputs the captured gas 520 as a dried captured gas 736 for subsequent compression in the compression system 530.

The compression system 530 may include a plurality of compressor components 738, such as a compressor 740, a compressor 742, and a cooling heat exchanger or intercooler 744. For example, the compressor 740 may be configured to compress the dried captured gas 736 in a first compression stage, the intercooler 744 may be configured to cool the dried captured gas 736 after the first compression stage by the compressor 740, and the compressor 742 may be configured to compress the dried captured gas 736 in a second compression stage after cooling by the intercooler 744. In certain embodiments, the compression system 530 may be a single stage compressor, or the compression components 180 may include 3, 4, 5, or more compressors and associated intercoolers. The compression system 530 then outputs a compressed captured gas 746 to the storage and/or pipeline system 532. Accordingly, the compressed captured gas 746 may be used for a variety of applications either locally in the combined cycle power plant 700 or remotely via the storage and/or pipeline system 532.

The water supply system 734 may receive fresh water, condensed water, or other plant water from various sources throughout the combined cycle power plant 700. For example, the water supply system 734 may receive water from the dehydration system 528 as indicated by arrow 748 (e.g., water conduit), water from the compression system 530 as indicated by arrow 750 (e.g., water conduit), and water from the gas treatment system 16 (e.g., water conduits from the cooling system 166 and/or the heating system 168). The water supply system 734 also may supply the water to various equipment throughout the combined cycle power plant 700. For example, the water supply system 734 may supply water to the HRSG 27 for steam generation of the steam 96 as indicated by arrow 752 (e.g., via water conduit), and water to the gas treatment system 16 for use in various cooling processes within the adsorption system 106. For example, the water supply system 734 may supply the cooled fluid 552 (e.g., water 554) to the cooling system 166 (e.g., cooling supply systems 410) as indicated by arrow 754 (e.g., via water conduit).

Given the various sources and uses of the water, the water supply system 734 may include a plurality of water components 756, such as a water storage 758, a thermal control system 760, and a water treatment system 762. The water storage 758 may include a water storage container, a water storage tower, a water supply conduit, a water reservoir or pond, or any combination thereof. The thermal control system 760 may include a heat exchanger and/or cooling system, which may be configured to control the temperature of the water depending on the desired use throughout the combined cycle power plant 700. For example, the thermal control system 760 may include a cooling tower, an indirect heat exchanger using another thermal fluid to provide cooling, one or more fans, a refrigeration system, a heating system using heat from various sources in the combined cycle power plant 700, or any combination thereof. The water treatment system 762 may include one or more of a filtration system, a chemical treatment system, an impurity removal system, an ultraviolet light treatment system, or any combination thereof. Accordingly, the water supply system 734 may supply a thermally controlled and treated water to various locations throughout the combined cycle power plant 700, including but not limited to the HRSG 27 and the gas treatment system 16 (e.g., cooling supply systems 410 of the adsorption system 106). In the illustrated embodiment, the water treatment system 762 in shared among various components, equipment, or sub-systems of the combined cycle power plant 700.

In operation, the controller 76 is configured to control the thermal control system 101 and the adsorption system 106 of the gas treatment system 16 to enable or improve the efficiency of the adsorption process in the adsorption unit 414 and the desorption process in the desorption unit 420. The temperature in the adsorption unit 414 impacts the adsorption process, and thus the controller 76 helps to control the temperature in the adsorption unit 414 at least partially based on the cooled fluid 552 being extracted from the combined cycle power plant 700. For example, the controller 76 may selectively control the extraction point (e.g., particular equipment, such as the HRSG 27, the steam turbine 29, the dehydration system 528, and/or the compression system 530), mixing of multiple extractions, additional heat exchange (e.g., adjustments by heating or cooling), or other parameters of the cooled fluid 552, such that the cooling supply systems 410 of the cooling system 166 receive the cooled fluid 552 at a temperature within a suitable temperature range for the adsorption process.

Similarly, the temperature in the desorption unit 420 impacts the desorption process, and thus the controller 76 helps to control the temperature in the desorption unit 420 at least partially based on the heated fluid 572 being extracted from the combined cycle power plant 700. For example, the controller 76 may selectively control the extraction point (e.g., particular equipment, such as the HRSG 27, the steam turbine 29, and the boiler 95), mixing of multiple extractions, additional heat exchange (e.g., adjustments by heating or cooling), or other parameters of the heated fluid 572, such that the heating supply systems 416 of the heating system 168 receive the heated fluid 572 at a temperature within a suitable temperature range for the desorption process. By further example, the controller 76 may selectively control the extraction point of the heated fluid 572 from the different sections 704 (e.g., LP section 706, IP section 708, and/or HP section 710) of the HRSG 27 and/or the different sections (e.g., LP turbine, IP turbine, and/or HP turbine) of the steam turbine 29, thereby providing LP steam, IP steam, and/or HP steam as the heated fluid 572 for the heating system 168. Overall, the controller 76 helps to control the temperatures in the adsorption and desorption units 414 and 420, movement of the adsorption modules 100 between the adsorption and desorption units 414 and 420, downstream equipment 522 to control the post-processing of the captured gas 520, and various equipment of the combined cycle power plant 700 to help support the adsorption system 106 of the gas treatment system 16.

Technical effects of the disclosed embodiments include a gas treatment system with adsorption modules that move in alternating directions between flow paths in first and second ducts, wherein the adsorption module adsorbs an undesirable gas in the first duct and desorbs the undesirable gas in the second duct. The first and second ducts may be positioned directly adjacent one another and may share an intermediate wall. The adsorption modules may be configured to move in alternating directions along one or more rail assemblies of a positioning system. The first duct may also be described as an adsorption duct, unit, or column, while the second duct may be described as a desorption duct, unit, or column. When multiple adsorption modules are installed in the ducts, a controller may control movement and positioning of the adsorption modules, such that one or more adsorption modules are adsorbing the undesirable gases in the first duct while one or more adsorption modules are desorbing the undesirable gases in the second duct. Additionally, a thermal control system is coupled to the gas treatment system for controlling the temperatures associated with the adsorption and desorption in the respective first and second ducts. The thermal control system may include one or more heat exchangers disposed in each duct, wherein the heat exchangers may transfer heat between one another (e.g., a closed-loop heat pump cycle or refrigeration cycle) and/or with external cooling supply systems. The heat exchangers may be disposed upstream of the adsorption modules, directly at and/or coupled to the adsorption modules, and/or between successive adsorption modules. The thermal control system enables temperature control, such that the temperature is within a suitable range for adsorption and a suitable range for desorption within the respective first and second ducts.

The subject matter described in detail above may be defined by one or more clauses, as set forth below.

A system includes a gas treatment system having an adsorption module, wherein the adsorption module includes a sorbent material. The gas treatment system further includes a positioning assembly configured to move the adsorption module in alternating directions along a path of travel between a first position in a first flow path and a second position in a second flow path. The gas treatment system is configured to adsorb an undesirable gas from a first fluid flow in the first flow path into the sorbent material when the adsorption module is disposed in the first position. The gas treatment system is configured to desorb the undesirable gas from the sorbent material when the adsorption module is disposed in the second position. The gas treatment system also includes a thermal control system having a first heat exchanger disposed in the first flow path and a second heat exchanger disposed in the second flow path.

The system of the preceding clause, including a heat transfer circuit extending through the first and second heat exchangers.

The system of any preceding clause, wherein the thermal control system includes a heat pump cycle or refrigeration cycle having the first heat exchanger, a compressor, the second heat exchanger, and an expansion valve arranged along the heat transfer circuit in a closed-loop.

The system of any preceding clause, including a moveable adsorption assembly having the adsorption module disposed in a housing, wherein the thermal control system has the first and second heat exchangers coupled to the housing along the first and second flow paths.

The system of any preceding clause, wherein the first heat exchanger is disposed along a first heat transfer circuit and the second heat exchanger is disposed along a second heat transfer circuit, wherein the first and second heat transfer circuits are separate from one another.

The system of any preceding clause, including a cooling supply system coupled to the first heat transfer circuit and a heating supply system coupled to the second heat transfer circuit.

The system of any preceding clause, wherein the cooling supply system is configured to receive a cooled fluid and circulate the cooled fluid as a cooling fluid through the first heat transfer circuit, or the heating supply system is configured to receive a heated fluid and circulate the heated fluid as a heating fluid through the second heat transfer circuit, or a combination thereof.

The system of any preceding clause, wherein the cooling supply system is configured to transfer heat between a first cooling fluid and a second cooling fluid in a third heat exchanger, wherein the cooling supply system is configured to circulate the first cooling fluid through the first heat transfer circuit; or the heating supply system is configured to transfer heat between a first heating fluid and a second heating fluid in a fourth heat exchanger, wherein the heating supply system is configured to circulate the first heating fluid through the second heat transfer circuit; or a combination thereof.

The system of any preceding clause, wherein the heating supply system includes a steam source configured to circulate a steam flow.

The system of any preceding clause, wherein the steam source includes a heat recovery steam generator (HRSG), a steam turbine, or a combination thereof.

The system of any preceding clause, wherein the cooling supply system includes a water source configured to circulate a water flow.

The system of any preceding clause, including a combustion system having the first flow path coupled to the gas treatment system, wherein the first flow path includes an exhaust flow path.

The system of any preceding clause, including an exhaust stack having the first flow path, wherein the second flow path extends along the first flow path, wherein the combustion system includes a gas turbine system.

The system of any preceding clause, wherein the undesirable gas includes carbon dioxide (CO₂).

The system of any preceding clause, including a controller coupled to the thermal control system, a drive, and one or more sensors, wherein the controller is configured to control the drive to move the adsorption module in the alternating directions between the first and second positions when feedback from the one or more sensors indicates that adsorption meets an adsorption threshold in the first flow path or desorption meets a desorption threshold in the second flow path, wherein the controller is configured to control the thermal control system to control a first temperature in the first flow path and to control a second temperature in the second flow path.

The system of any preceding clause, wherein the gas treatment system includes a plurality of adsorption modules and a respective plurality of positioning assemblies, the plurality of adsorption modules includes the adsorption module, and the plurality of positioning assemblies includes the positioning assembly.

A system includes a first duct having a first flow path, a second duct having a second flow path, and a plurality of adsorption modules, wherein each adsorption module of the plurality of adsorption modules includes a sorbent material. The system further includes a plurality of positioning assemblies, wherein each positioning assembly of the plurality of positioning assemblies is configured to independently move one of the plurality of adsorption modules in alternating directions between the first and second ducts. The system also includes a thermal control system having a first heat exchanger disposed in the first flow path and a second heat exchanger disposed in the second flow path.

The system of the preceding clause, including a heat transfer circuit extending through the first and second heat exchangers.

The system of any preceding clause, wherein the first heat exchanger is disposed along a first heat transfer circuit and the second heat exchanger is disposed along a second heat transfer circuit, wherein the first and second heat transfer circuits are separate from one another.

A method includes moving, via a positioning assembly, an adsorption module of a gas treatment system in alternating directions along a path of travel between a first position in a first flow path and a second position in a second flow path, wherein the adsorption module includes a sorbent material. The method includes adsorbing an undesirable gas into the sorbent material of the adsorption module when the adsorption module is disposed in the first position in the first flow path. The method includes controlling a first temperature in the first flow path via a first heat exchanger of a thermal control system, wherein the first heat exchanger is disposed in the first flow path. The method includes desorbing the undesirable gas from the sorbent material of the adsorption module when the adsorption module is disposed in the second position in the second flow path. The method includes controlling a second temperature in the second flow path via a second heat exchanger of the thermal control system, wherein the second heat exchanger is disposed in the second flow path.

This written description uses examples to describe the present embodiments, including the best mode, and also to enable any person skilled in the art to practice the presently disclosed embodiments, including making and using any devices or systems and performing any incorporated methods. The patentable scope of the presently disclosed embodiments is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gas treatment system, comprising:
an adsorption module having a sorbent material;
a positioning assembly configured to move the adsorption module in alternating directions along a path of travel between a first position in a first flow path and a second position in a second flow path, wherein the gas treatment system is configured to adsorb an undesirable gas from a first fluid flow in the first flow path into the sorbent material when the adsorption module is disposed in the first position, wherein the gas treatment system is configured to desorb the undesirable gas from the sorbent material when the adsorption module is disposed in the second position;
a thermal control system having a first heat exchanger disposed in the first flow path and a second heat exchanger disposed in the second flow path.

2. The system of claim 1, comprising a heat transfer circuit extending through the first and second heat exchangers.

3. The system of claim 2, wherein the thermal control system comprises a heat pump cycle or refrigeration cycle having the first heat exchanger, a compressor, the second heat exchanger, and an expansion valve arranged along the heat transfer circuit in a closed-loop.

4. The system of claim 2, comprising a moveable adsorption assembly having the adsorption module disposed in a housing, wherein the thermal control system has the first and second heat exchangers coupled to the housing along the first and second flow paths.

5. The system of claim 1, wherein the first heat exchanger is disposed along a first heat transfer circuit and the second heat exchanger is disposed along a second heat transfer circuit, wherein the first and second heat transfer circuits are separate from one another.

6. The system of claim 5, comprising a cooling supply system coupled to the first heat transfer circuit and a heating supply system coupled to the second heat transfer circuit.

7. The system of claim 6, wherein the cooling supply system is configured to receive a cooled fluid and circulate the cooled fluid as a cooling fluid through the first heat transfer circuit, or the heating supply system is configured to receive a heated fluid and circulate the heated fluid as a heating fluid through the second heat transfer circuit, or a combination thereof.

8. The system of claim 6, wherein:
the cooling supply system is configured to transfer heat between a first cooling fluid and a second cooling fluid in a third heat exchanger, wherein the cooling supply system is configured to circulate the first cooling fluid through the first heat transfer circuit; or
the heating supply system is configured to transfer heat between a first heating fluid and a second heating fluid in a fourth heat exchanger, wherein the heating supply system is configured to circulate the first heating fluid through the second heat transfer circuit; or
a combination thereof.

9. The system of claim 5, wherein the heating supply system comprises a steam source configured to circulate a steam flow.

10. The system of claim 9, wherein the steam source comprises a heat recovery steam generator (HRSG), a steam turbine, or a combination thereof.

11. The system of claim 5, wherein the cooling supply system comprises a water source configured to circulate a water flow.

12. The system of claim 1, comprising a combustion system having the first flow path coupled to the gas treatment system, wherein the first flow path comprises an exhaust flow path.

13. The system of claim 12, comprising an exhaust stack having the first flow path, wherein the second flow path extends along the first flow path, wherein the combustion system comprises a gas turbine system.

14. The system of claim 1, wherein the undesirable gas comprises carbon dioxide (CO₂).

15. The system of claim 1, comprising a controller coupled to the thermal control system, a drive, and one or more sensors, wherein the controller is configured to control the drive to move the adsorption module in the alternating directions between the first and second positions when feedback from the one or more sensors indicates that adsorption meets an adsorption threshold in the first flow path or desorption meets a desorption threshold in the second flow path, wherein the controller is configured to control the thermal control system to control a first temperature in the first flow path and to control a second temperature in the second flow path.

16. The system of claim 1, wherein the gas treatment system comprises a plurality of adsorption modules and a respective plurality of positioning assemblies, the plurality of adsorption modules includes the adsorption module, and the plurality of positioning assemblies includes the positioning assembly.

17. A system, comprising:
a first duct having a first flow path;
a second duct having a second flow path;
a plurality of adsorption modules, wherein each adsorption module of the plurality of adsorption modules comprises a sorbent material; and
a plurality of positioning assemblies, wherein each positioning assembly of the plurality of positioning assemblies is configured to independently move one of the plurality of adsorption modules in alternating directions between the first and second ducts; and
a thermal control system having a first heat exchanger disposed in the first flow path and a second heat exchanger disposed in the second flow path.

18. The system of claim 17, comprising a heat transfer circuit extending through the first and second heat exchangers.

19. The system of claim 17, wherein the first heat exchanger is disposed along a first heat transfer circuit and the second heat exchanger is disposed along a second heat transfer circuit, wherein the first and second heat transfer circuits are separate from one another.

20. A method, comprising:
moving, via a positioning assembly, an adsorption module of a gas treatment system in alternating directions along a path of travel between a first position in a first flow path and a second position in a second flow path, wherein the adsorption module comprises a sorbent material;
adsorbing an undesirable gas into the sorbent material of the adsorption module when the adsorption module is disposed in the first position in the first flow path;
controlling a first temperature in the first flow path via a first heat exchanger of a thermal control system, wherein the first heat exchanger is disposed in the first flow path;
desorbing the undesirable gas from the sorbent material of the adsorption module when the adsorption module is disposed in the second position in the second flow path;
controlling a second temperature in the second flow path via a second heat exchanger of the thermal control system, wherein the second heat exchanger is disposed in the second flow path.
